(19) United States
(12) Patent Application Publication
(10) Pub. No.: US 2025/0230092 A1
(43) Pub. Date: Jul. 17, 2025

(54) WINDOW MANUFACTURING DEVICE, WINDOW MANUFACTURING METHOD USING THE DEVICE, AND ELECTRONIC DEVICE INCLUDING THE WINDOW

(71) Applicant: Samsung Display Co., LTD., Yongin-si (KR)

(72) Inventors: SEUNGPYO HONG, Yongin-si (KR); DONG-CHEON SHIN, Yongin-si (KR); HYUNCHUL KIM, Yongin-si (KR); JUSUK OH, Yongin-si (KR)

(21) Appl. No.: 19/018,514

(22) Filed: Jan. 13, 2025

(30) Foreign Application Priority Data
Jan. 15, 2024 (KR) 10-2024-0006149
Oct. 10, 2024 (KR) 10-2024-0137281

(51) Int. Cl. C03C 15/00

(52) U.S. Cl. CPC C03C 15/00

(57) ABSTRACT

A window manufacturing device includes a fixing jig with a seating surface, on which a workpiece is fixed, where the seating surface includes a curved surface or an inclined surface, and an etching solution supply part disposed below the fixing jig, where a storage part is defined in the etching solution supply part to accommodate at least a portion of the seating surface.

This application claims priority to Korean Patent Application No. 10-2024-0006149, filed on Jan. 15, 2024, and Korean Patent Application No. 10-2024-0137281, filed on Oct. 10, 2024, and all the benefits accruing therefrom under 35 U.S.C. § 19, the contents of which in their entireties are herein incorporated by reference.

### BACKGROUND

### (1) Field

The disclosure herein relates to a window manufacturing device and a window manufacturing method, and more particularly, to a window manufacturing device for manufacturing a window including a partially slimmed region and a window manufacturing method using the device.

### (2) Description of the Related Art

Various types of electronic devices are being used to provide image information, and electronic devices including a flexible display panel capable of being folded or bent have been developed recently. Unlike rigid electronic devices, flexible electronic devices may be folded, rolled, or bent in various shapes and thus can be carried regardless of the screen size on which an image is displayed.

### SUMMARY

A flexible electronic device typically includes a window to protect the display panel without hindering folding or bending operation. Accordingly, it is desired to develop a manufacturing method and a manufacturing device for manufacturing a window having good folding properties and surface characteristics that do not affect display quality.

Embodiments of the disclosure provides a manufacturing method and a manufacturing device for manufacturing a window having improved surface characteristics.

Embodiments of the disclosure also provides a window manufacturing method and a window manufacturing device, which have high process efficiency and easily control the shape of a slimming region of the window.

An embodiment of the invention provides a window manufacturing device including: a fixing jig with a seating surface, on which a workpiece is fixed, where the seating surface includes a curved surface or an inclined surface; and an etching solution supply part disposed below the fixing jig, where a storage part is defined in the etching solution supply part and to accommodate at least a portion of the seating surface.

In an embodiment, the seating surface may protrude toward the storage part and include the curved surface or the inclined surface without a discontinuity.

In an embodiment, a position of the fixing jig may be adjusted in a way such that at least a portion of the seating surface is positioned inside the storage part.

In an embodiment, vacuum suction inlets may be defined on the seating surface.

In an embodiment, the fixing jig may include a groove portion concavely recessed toward the storage part and extending in one direction.

In an embodiment, the seating surface may define the groove portion.

In an embodiment, vacuum suction inlets may be defined on the seating surface.

In an embodiment, the groove portion may include the curved surface or the inclined surface without a discontinuity.

In an embodiment, the fixing jig may be entirely accommodated in the storage part.

In an embodiment, an etching solution provided in the storage part may be maintained at a constant level, or the level of the etching solution in the storage part may be adjusted over time.

In an embodiment of the invention, a window manufacturing method using a window manufacturing device including a fixing jig with a seating surface including a curved or inclined surface and an etching solution supply part disposed below the fixing jig with a storage part defined therein to accommodate at least a portion of the seating surface is provided. The window manufacturing method according to an embodiment of the invention includes: bending a base glass to include a bending portion corresponding to the seating surface; fixing the bent base glass to the seating surface of the fixing jig; supplying an etching solution to the storage part of the etching solution supply part; and exposing the base glass, which is fixed to correspond to the curved or inclined surface, to the etching solution.

In an embodiment, the exposing the base glass to the etching solution may include etching one exposed surface of the base glass to form a window, in which a recessed portion including a curved surface or an inclined surface is defined on a surface provided with the etching solution without a discontinuity.

In an embodiment, the exposing the base glass to the etching solution may include controlling at least one selected from an exposure time to the etching solution or an amount of the etching solution to be provided, depending on a position of the base glass.

In an embodiment, when the bending portion is fixed to the seating surface, and remaining portions of the base glass spaced apart from each other with the bending portion interposed therebetween may be positioned in a direction in which the remaining portions are spaced apart from the storage part.

In an embodiment, the seating surface, on which the base glass is fixed, may have a shape protruding toward the storage part, and the exposing the base glass to the etching solution may include immersing one surface of the base glass in the etching solution of the storage part.

In an embodiment, in the exposing the base glass to the etching solution, a thickness of the base glass immersed in the etching solution may gradually decrease from a central portion of the fixing jig towards an outer edge of the fixing jig.

In an embodiment, the seating surface, on which the base glass is fixed, may define a groove portion concave in a direction toward the storage part, and the exposing of the base glass to the etching solution may include accommodating the fixing jig, to which the base glass is fixed, in the storage part to provide the etching solution to a portion of the base glass.

In an embodiment, the exposing of the base glass to the etching solution may include controlling a level of the etching solution supplied to the storage part.

In an embodiment, the window manufacturing method may further include attaching a protective film to one surface of the base glass prior to the bending the base glass.

In an embodiment, in the fixing the base glass to the seating surface of the fixing jig, the protective film side may be attached to the seating surface.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain principles of the invention. In the drawings:

FIG. 1A is a perspective view illustrating an unfolded state of an electronic device according to an embodiment of the invention;

FIG. 1B is a perspective view illustrating an in-folding process of the electronic device according to an embodiment of the invention illustrated in FIG. 1A;

FIG. 1C is a perspective view illustrating an out-folding process of the electronic device according to an embodiment of the invention illustrated in FIG. 1A;

FIG. 2A is a perspective view illustrating an unfolded state of an electronic device according to an embodiment of the invention;

FIG. 2B is a perspective view illustrating an in-folding process of the electronic device according to an embodiment of the invention illustrated in FIG. 2A;

FIG. 2C is a perspective view illustrating an out-folding process of the electronic device according to an embodiment of the invention illustrated in FIG. 2A;

FIG. 3A is a perspective view of an electronic device according to an embodiment of the invention;

Each of FIG. 3B and FIG. 3C is a perspective view of the electronic device illustrated in FIG. 3A in a multi-folded state;

FIG. 4 is an exploded perspective view of an electronic device according to an embodiment of the invention;

FIG. 5 is a cross-sectional view of the electronic device according to an embodiment of the invention;

Each of FIGS. 6A and 6B is a cross-sectional view of a window according to an embodiment of the invention;

FIG. 7 is a perspective view of a window manufacturing device according to an embodiment of the invention;

Each of FIGS. 8A and 8B is a cross-sectional view of a fixing jig according to an embodiment of the invention;

FIG. 9 is a cross-sectional view of the window manufacturing device according to an embodiment of the invention;

FIG. 10 is a perspective view of a window manufacturing device according to an embodiment of the invention;

Each of FIGS. 11A and 11B is a cross-sectional view of a fixing jig according to an embodiment of the invention;

FIG. 12 is a cross-sectional view of the window manufacturing device according to an embodiment of the invention;

FIG. 13 is a flow chart of a window manufacturing method according to an embodiment of the invention;

Each of FIGS. 14A to 14D illustrates one process of the window manufacturing method according to an embodiment of the invention;

Each of FIGS. 15A to 15D illustrates one process of the window manufacturing method according to an embodiment of the invention; and

Each of FIGS. 16A to 16C illustrates one process of the window manufacturing method according to an embodiment of the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

In this specification, it will be understood that when an element (or region, layer, portion, etc.) is referred to as being “on”, “connected to” or “coupled to” another element, it can be directly on, connected or coupled to the other element, or intervening elements may be present there between.

Like reference numerals refer to like elements throughout. In addition, in the drawings, the thicknesses, ratios, and dimensions of elements are exaggerated for effective description of the technical contents.

It will be understood that, although the terms first, second, etc. may be used herein to describe various elements, these elements should not be limited by these terms. These terms are only used to distinguish one element from another element. For example, a first element could be termed a second element without departing from the scope of the invention. Similarly, the second element may also be referred to as the first element.

In addition, terms, such as “below”, “lower”, “above”, “upper” and the like, are used herein for ease of description to describe one element's relation to another element(s) as illustrated in the figures. The above terms are relative concepts and are described based on the directions indicated in the drawings.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

In this specification, the expression “being directly disposed” may mean that there is no layer, film, region, plate, or the like which is added between a part of a layer, film, region, plate, or the like and another part. For example, the expression “being directly disposed” may mean being disposed between two layers or two members without an additional member such as an adhesive member interposed therebetween.

In this specification, the expression “a region/portion corresponds to another region/portion” means that “they overlap each other”, but the expression is not limited to having a same area and/or a same shape. In addition, in this specification, the expression “a region/portion overlaps another region/portion” includes a case in which the regions/portions indicated as overlapping each other when viewed on a plane at least partially overlap each other on a plane.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, an electronic device according to an embodiment of the invention, a window manufacturing device according to an embodiment of the invention, and a window manufacturing method according to an embodiment of the invention will be described with reference to the drawings.

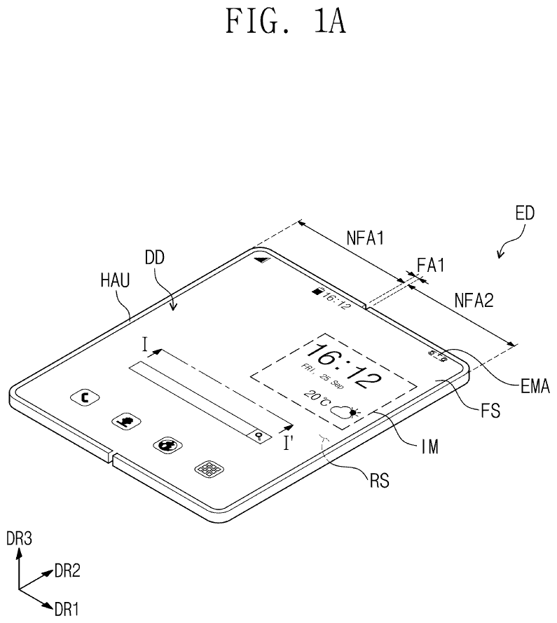

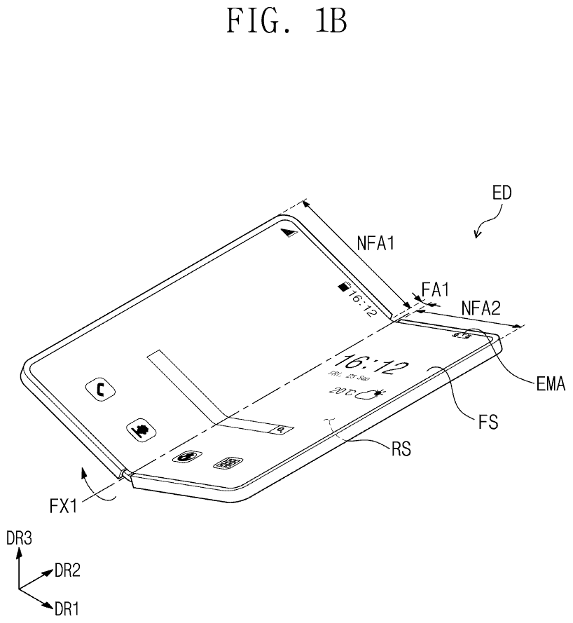

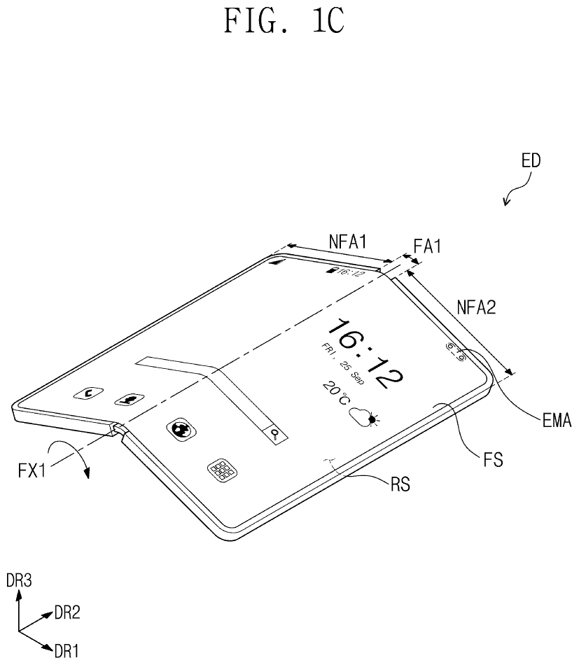

FIGS. 1A to 5 illustrate an electronic device according to an embodiment of the invention, and the electronic device according to an embodiment of the invention illustrated in FIGS. 1A to 5 includes a window manufactured by a window manufacturing device according to an embodiment of the invention and a window manufacturing method according to an embodiment of the invention, which will be described later.

FIG. 1A is a perspective view illustrating an unfolded state of an electronic device according to an embodiment of the invention. FIG. 1B is a perspective view illustrating an in-folding process of the electronic device illustrated in FIG. 1A. FIG. 1C is a perspective view illustrating an out-folding process of the electronic device illustrated in FIG. 1A.

The electronic device ED according to an embodiment of the invention may be activated according to an electrical signal. In an embodiment, for example, the electronic device ED may be a mobile phone, a tablet, a car navigation system, a game console, or a wearable device, but the embodiment of the invention is not limited thereto. In an embodiment, as shown in FIG. 1A, the electronic device ED may be a mobile phone, but not being limited thereto.

Referring to FIGS. 1A to 1C, the electronic device ED according to an embodiment of the invention may include a first display surface FS on a plane defined by a first directional axis (or first axis direction) DR1 and a second directional axis (or a second axis direction) DR2 crossing the first directional axis DR1. The electronic device ED may provide an image IM to a user through the first display surface FS. The electronic device ED according to an embodiment of the invention may display an image IM toward a third directional axis (or third axis direction) DR3 on the first display surface FS parallel to each of the first directional axis DR1 and the second directional axis DR2. In the disclosure, the front (or upper) and rear (or lower) surfaces of each component are defined based on the direction in which the image IM is displayed. The front and rear surfaces may be opposed to each other in the third directional axis DR3, and the normal direction of each of the front surface and the rear surface may be parallel to the third directional axis DR3. Here, the third directional axis DR3 may correspond to a thickness direction of the electronic device ED.

The electronic device ED according to an embodiment of the invention may include a first display surface FS and a second display surface RS. The first display surface FS may include an electronic module region EMA. The second display surface RS may be defined as a surface opposed to at least a portion of the first display surface FS. In other words, the second display surface RS may be defined as a portion of the rear surface of the electronic device ED.

The electronic device ED according to an embodiment of the invention may sense an external input applied from the outside. The external input may include various types of inputs provided from the outside of the electronic device ED. In an embodiment, for example, the external input may include not only a touch by a part of a body such as a user's hand, but also an external input (e.g., hovering) applied at a place close to or at a predetermined close distance from the electronic device ED. In addition, the external input may have various forms, such as force, pressure, temperature, and light.

In FIG. 1A and the drawings below, the first directional axis DR1 to the third directional axis DR3 are illustrated, and the directions indicated by the first to third directional axes DR1, DR2, and DR3 described in this specification are relative concepts and may be converted into other directions. In addition, the directions indicated by the first to third directional axes DR1, DR2, and DR3 may be described as first to third directions, and the same reference numerals may be used for them.

The first display surface FS of the electronic device ED may include an active region which is activated according to an electrical signal. The electronic device ED according to an embodiment of the invention may display an image IM through the first display surface FS. In addition, the first display surface FS may sense various types of external inputs.

The electronic device ED may include a folding region FA1 and non-folding regions NFA1 and NFA2. In an embodiment of the invention, the non-folding regions NFA1 and NFA2 may be disposed adjacent to the folding region FA1 with the folding region FA1 interposed therebetween. The electronic device ED according to an embodiment of the invention may include a first non-folding region NFA1 and a second non-folding region NFA2 disposed to be spaced apart from each other in the direction of the first directional axis DR1 with the folding region FA1 interposed therebetween. In an embodiment, for example, the first non-folding region NFA1 may be disposed on one side of the folding region FA1 along the first direction DR1, and the second non-folding region NFA2 may be disposed on the other side of the folding region FA1 along the first direction DR1.

Although FIGS. 1A to 1C illustrate an embodiment of the electronic device ED including one folding region FA1, the embodiment of the invention is not limited thereto, and a plurality of folding regions may be defined in the electronic device ED. For example, an electronic device according to an embodiment of the invention may include two or more folding regions and may also include three or more non-folding regions disposed with each of the folding regions interposed therebetween.

Referring to FIG. 1B, the electronic device ED according to an embodiment of the invention may be folded based on a first folding axis FX1. The first folding axis FX1 is a virtual axis extending in the direction of the second directional axis DR2, and the first folding axis FX1 may be parallel to the long side direction of the electronic device ED. The first folding axis FX1 may extend along the second directional axis DR2 on the first display surface FS.

The electronic device ED may be folded based on the first folding axis FX1 and may be transformed into an in-folded state in which one region of the first display surface FS overlapping the first non-folding region NFA1 and the other region thereof overlapping the second non-folding region NFA2 face each other.

The second display surface RS of the electronic device ED according to an embodiment of the invention may be visually recognized by a user in an in-folded state. The second display surface RS may further include an electronic module region in which an electronic module including various components are disposed, and the invention is not limited to any one embodiment.

Referring to FIG. 1C, the electronic device ED according to an embodiment of the invention may be folded based on the first folding axis FX1 and may be transformed into an out-folded state in which one region of the second display surface RS overlapping the first non-folding region NFA1 and the other region thereof overlapping the second non-folding region NFA2 face each other.

However, the embodiment of the invention is not limited thereto, and the electronic device ED may be folded based on a plurality of folding axes so that portions of the first display surface FS and the second display surface RS face each other, and the number of folding axes and the number of non-folding regions according thereto are not particularly limited.

Various electronic modules may be disposed in the electronic module region EMA. In an embodiment, for example, an electronic module may include at least one selected from a camera, a speaker, a light sensor, and a heat sensor. The electronic module region EMA may sense an external subject received through the first or second display surface FS or RS or provide a sound signal such as a voice to the outside through the first or second display surface FS or RS. The electronic module may include a plurality of components and is not limited to any one embodiment.

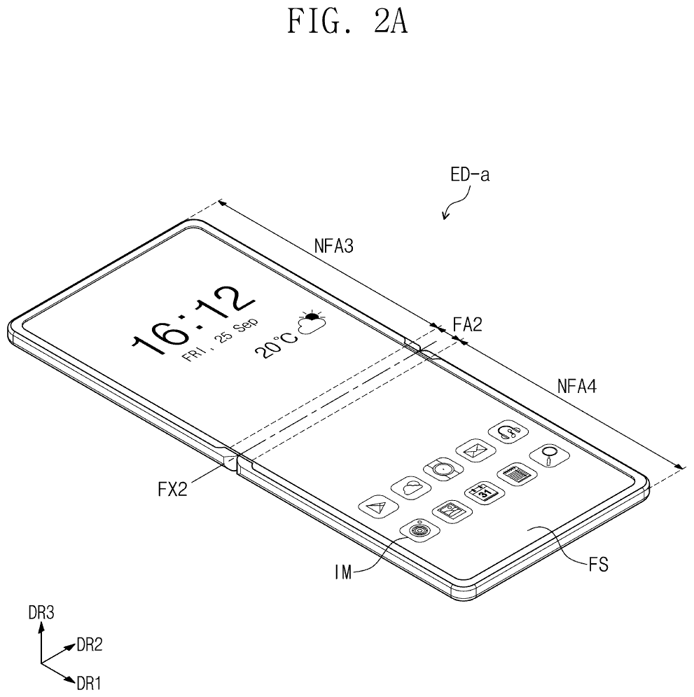

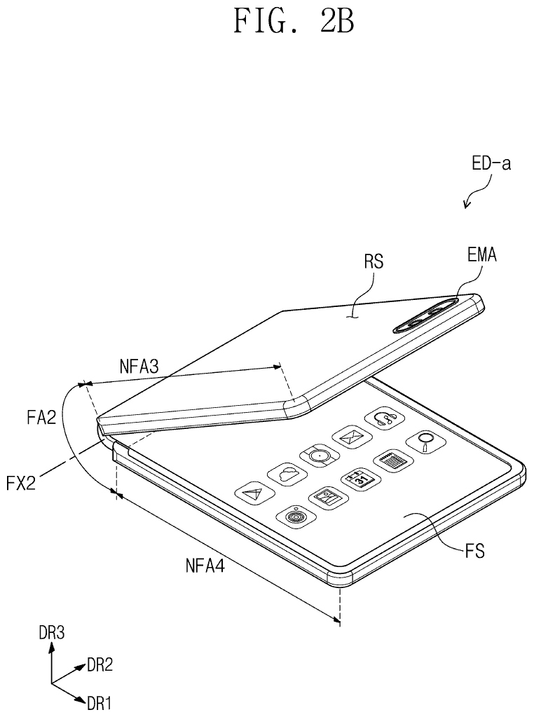

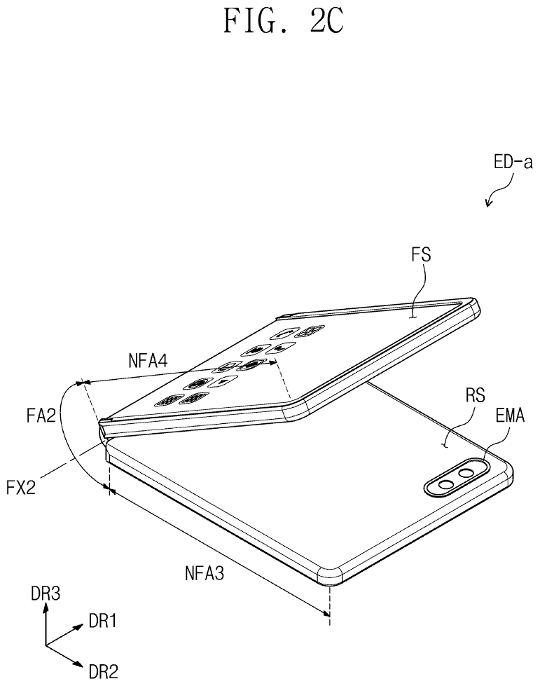

FIG. 2A is a perspective view illustrating an unfolded state of an electronic device according to an embodiment of the invention. FIG. 2B is a perspective view illustrating an in-folding process of the electronic device illustrated in FIG. 2A. FIG. 2C is a perspective view illustrating an out-folding process of the electronic device illustrated in FIG. 2A.

An electronic device ED-a according to an embodiment of the invention may be folded based on a second folding axis FX2 extending in one direction parallel to the second directional axis DR2. FIG. 2B illustrates a case in which the extension direction of the second folding axis FX2 is parallel to the extension direction of the short side of the electronic device ED-a. However, the embodiment of the invention is not limited thereto.

The electronic device ED-a according to an embodiment of the invention may include at least one folding region FA2 and non-folding regions NFA3 and NFA4 adjacent to the folding region FA2. The non-folding regions NFA3 and NFA4 may be disposed to be spaced apart from each other with the folding region FA2 interposed therebetween.

The folding region FA2 has a predetermined curvature and a predetermined curvature radius. In an embodiment of the invention, the first non-folding region NFA3 and the second non-folding region NFA4 may face each other, and the electronic device ED-a may be in-folded so that the first display surface FS is not exposed to the outside. In addition, referring to FIG. 2C, in an embodiment of the invention, the electronic device ED-a may be out-folded so that the first display surface FS is exposed to the outside.

The electronic device ED-a according to an embodiment of the invention may include a second display surface RS, and the second display surface RS may be defined as a surface opposed to at least a portion of the first display surface FS. The second display surface RS may include an electronic module region EMA in which an electronic module including various components is disposed. In addition, an image or video may be displayed on at least a portion of the second display surface RS.

In an embodiment of the invention, the first display surface FS of the electronic device ED-a may be visible to a user in an unfolded state, and the second display surface RS thereof may be visible to a user in an in-folded state.

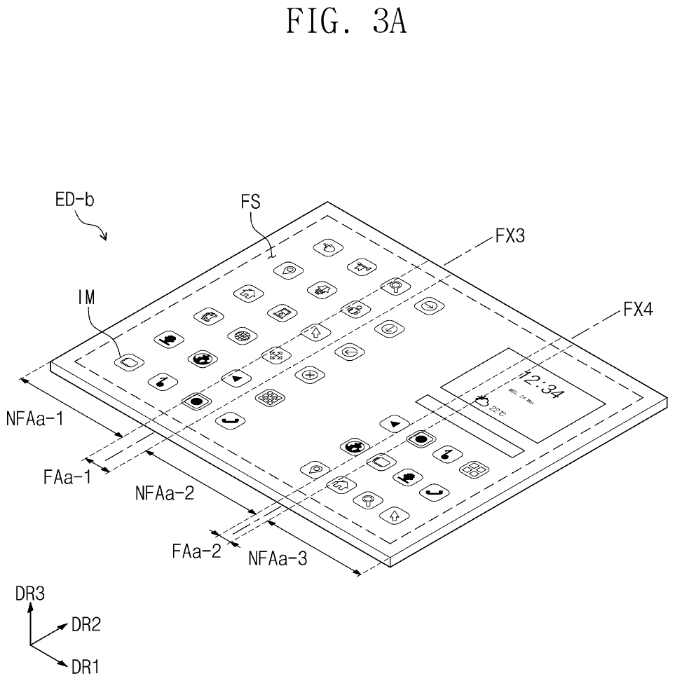

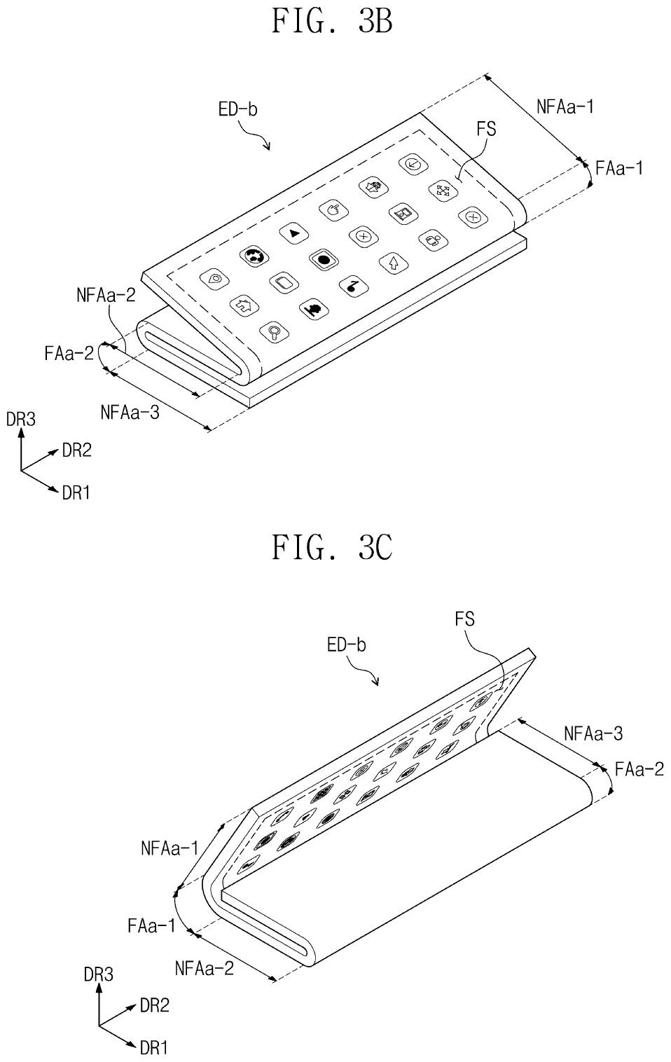

FIG. 3A is a perspective view illustrating an unfolded state of an electronic device ED-b according to an embodiment of the invention. Each of FIGS. 3B and 3C is a perspective view of the electronic device ED-b illustrated in FIG. 3A in a multi-folded state.

Referring to FIGS. 3A to 3C, the electronic device ED-b according to an embodiment of the invention may be a multi-foldable device including a plurality of folding regions. The electronic device ED-b may include a plurality of folding regions FAa-1 and FAa-2 and a plurality of non-folding regions NFAa-1, NFAa-2, and NFAa-3. The electronic device ED-b according to an embodiment of the invention may include a first folding region FAa-1, a second folding region FAa-2, a first non-folding region NFAa-1, a second non-folding region NFAa-2, and a third non-folding region NFAa-3. In the first direction DR1, the first folding region FAa-1 is disposed between the first non-folding region NFAa-1 and the second non-folding region NFAa-2, and the second folding region FAa-2 is disposed between the second non-folding region NFAa-2 and the third non-folding region NFAa-3. FIGS. 3A to 3C illustrate an embodiment including two folding regions FAa-1 and FAa-2 and three non-folding regions NFAa-1, NFAa-2, and NFAa-3 as an example, but the number of folding regions FAa-1 and FAa-2 and non-folding regions NFAa-1, NFAa-2, and NFAa-3 is not limited thereto and may further increase.

Referring to FIGS. 3A and 3B, the first folding region FAa-1 may be folded based on a third folding axis FX3 parallel to the second direction DR2. The first folding region FAa-1 may be out-folded so that the rear surface of the second non-folding region NFAa-2 faces the rear surface of the first non-folding region NFAa-1 and the display surface of the first non-folding region NFAa-1 faces the outside. The second folding region FAa-2 may be folded based on a fourth folding axis FX4 parallel to the second direction DR2. The second folding region FAa-2 may be in-folded so that the display surface of the second non-folding region NFAa-2 and the display surface of the third non-folding region NFAa-3 face each other.

Referring to FIGS. 3A and 3C, the second folding region FAa-2 may be folded based on the fourth folding axis FX4 parallel to the second direction DR2. The electronic device ED-b may be in-folded so that the display surface of the second non-folding region NFAa-2 is disposed inside and the display surface of the third non-folding region NFAa-3 and the display surface of the second non-folding region NFAa-2 face each other. The first folding region FAa-1 may be folded based on the third folding axis FX3 parallel to the second direction DR2. The electronic device ED-b may be in-folded so that the rear surface of the third non-folding region NFAa-3 and the display surface of the first non-folding region NFAa-1 face each other.

It will be understood that the multi-folded state is not limited to the form illustrated in FIGS. 3B and 3C, and the electronic device ED-b according to an embodiment of the invention may have various folding forms.

In an embodiment of the invention, the out-folding operation and the in-folding operation may occur simultaneously, and only one of the out-folding operation and the in-folding operation may occur.

In an embodiment of the invention, the electronic device ED, ED-a, or ED-b may be configured in a way such that an in-folding or out-folding operation is alternately repeated from an unfolding operation, but the embodiment of the invention is not limited thereto. In an embodiment of the invention, the electronic device ED, ED-a, or ED-b may be configured to perform an unfolding operation, an in-folding operation, or an out-folding operation. In an embodiment, where a plurality of folding regions are provided, the folding direction of at least one of the plurality of folding regions may be different from the folding directions of the remaining folding regions. In an embodiment, for example, where two folding regions are provided, two non-folding regions with one folding region interposed therebetween may be folded by an in-folding operation, and two non-folding regions with the remaining one folding region interposed therebetween may be folded by an out-folding operation.

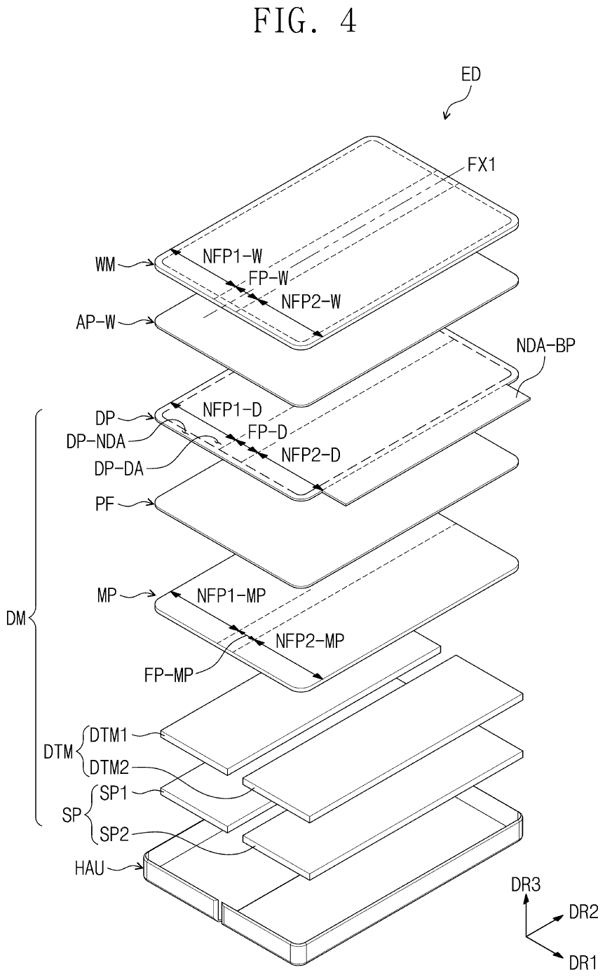

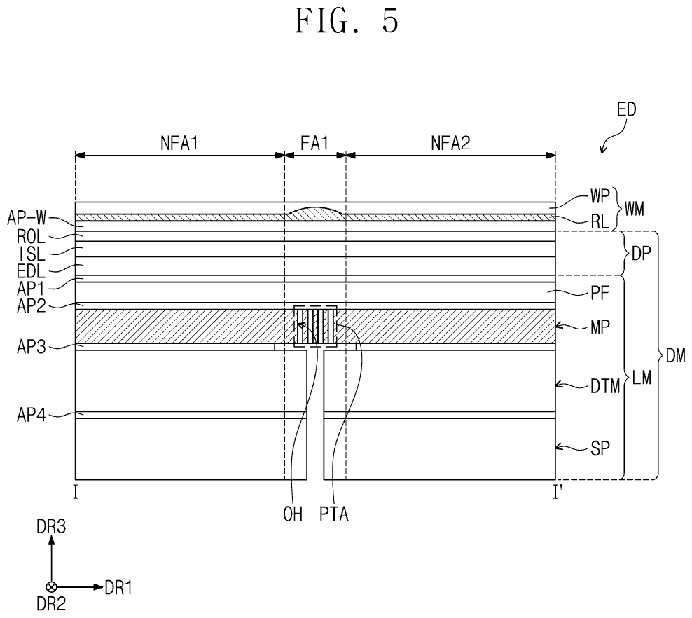

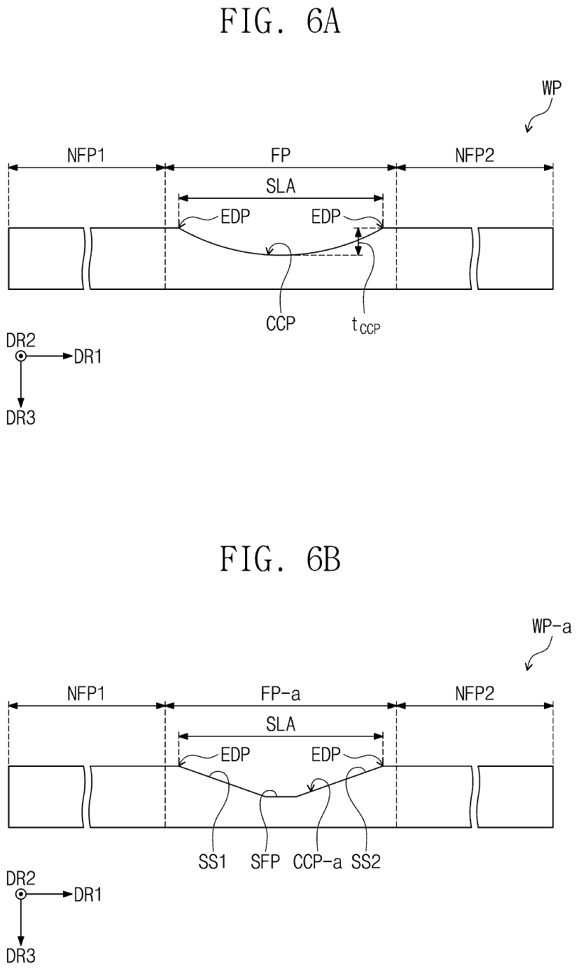

FIG. 4 is an exploded perspective view of an electronic device according to an embodiment of the invention. FIG. 5 is a cross-sectional view illustrating a portion of the electronic device according to an embodiment of the invention. FIG. 5 is a cross-sectional view illustrating a portion corresponding to line I-I′ of FIG. 1A.

FIGS. 4 and 5, etc. illustrate an embodiment in which the first folding axis FX1 of the electronic device ED illustrated in FIG. 1A, etc. is parallel to the long side of the electronic device ED, but the embodiment of the invention is not limited thereto, and the content described with reference to the drawings below may be applied to a case in which the second folding axis FX2 is parallel to the short side of the electronic device as illustrated in FIG. 2A, etc., or may also be applied to the electronic device that is multi-folded as illustrated in FIG. 3A, etc.

The electronic device ED according to an embodiment of the invention may include a display module DM, a window module WM, and a housing HAU that accommodates the display module DM and the window module WM.

The display module DM may include a display panel DP and a lower module LM disposed below the display panel DP. The lower module LM may include a support plate MP. In addition, in an embodiment of the invention, the lower module LM of the display module DM may further include at least one selected from a protective layer PF, a support member SP, adhesive layers AP1, AP2, AP3, and AP4, and a digitizer module DTM in addition to the support plate MP.

The display panel DP may display an image based on an electrical signal and transmit/receive information about an external input. The display panel DP may include a display region DP-DA and a non-display region DP-NDA. The display region DP-DA may be defined as a region that emits an image provided from the display panel DP.

The non-display region DP-NDA is adjacent to the display region DP-DA. In an embodiment, for example, the non-display region DP-NDA may surround the display region DP-DA. However, this is illustrated as an example, and the non-display region DP-NDA may be defined in various shapes and is not limited to any one embodiment. In addition, the display panel DP may include a non-display bending portion NDA-BP disposed on at least one side of the non-display region DP-NDA. The non-display bending portion NDA-BP may be bent toward the lower side of the display module DM and disposed to overlap at least a portion of the display panel DP. A circuit layer, a connection line, a circuit board, or the like for displaying an image or transmitting/receiving information may be mounted on or attached to the non-display bending portion NDA-BP.

In an embodiment of the invention, the display panel DP includes a display layer EDL. The display layer EDL may be a component that substantially generates an image. The image generated by the display layer EDL may be viewed by an external user through the first display surface FS (see FIG. 1A). The display layer EDL may be a light-emitting display layer, but the embodiment of the invention is not particularly limited thereto. In an embodiment, for example, the display layer EDL may be an organic light-emitting display layer or an inorganic light-emitting display layer. The organic light-emitting display layer may include a light-emitting element including an organic light-emitting material in a light-emitting layer. In addition, the inorganic light-emitting display layer may include a light-emitting element including a material such as a quantum dot and a quantum rod in a light-emitting layer.

The display panel DP may further include a sensor layer ISL. The sensor layer ISL may be disposed directly on the display layer EDL. The sensor layer ISL may include a plurality of sensing electrodes. The sensor layer ISL may sense an external input by a self-capacitance method or a mutual-capacitance method. The sensor layer ISL may also sense an input by an active-type input device.

In an embodiment, for example, the sensor layer ISL may be formed directly on the display layer EDL through a continuous process when the display layer EDL is manufactured. However, the embodiment of the invention is not limited thereto, and the sensor layer ISL may be manufactured as a panel separate from the display layer EDL and then may be attached to the display layer EDL by an adhesive layer (not illustrated).

In addition, the display panel DP may further include an optical layer ROL. The optical layer ROL may have a function of reducing the reflection of external light. In an embodiment, for example, the optical layer ROL may include a polarizing layer or a color filter layer. However, the embodiment of the invention is not limited thereto, and the optical layer ROL may include optical members for improving the display quality of the display module DM.

In an embodiment of the invention, the optical layer ROL may be disposed directly on the sensor layer ISL. In addition, when the sensor layer ISL is omitted from the display panel DP, the optical layer ROL may be disposed directly on the display layer EDL. However, the embodiment of the invention is not limited thereto, and the optical layer ROL may be disposed on the display layer EDL or the sensor layer ISL using a separate adhesive member.

The display panel DP may include a folding display portion FP-D and non-folding display portions NFP1-D and NFP2-D. The folding display portion FP-D may correspond to the folding region FA1 (see FIG. 1A), and the non-folding display portions NFP1-D and NFP2-D may correspond to the non-folding regions NFA1 and NFA2 (see FIG. 1A). The folding display portion FP-D and the non-folding display portions NFP1-D and NFP2-D of the display panel DP may be respectively referred to as the folding display portion and the non-folding display portions of the display module DM.

The folding display portion FP-D may correspond to a portion that is folded or bent based on the first folding axis FX1 (see FIG. 1B). The display panel DP may include a first non-folding display portion NFP1-D and a second non-folding display portion NFP2-D, and the first non-folding display portion NFP1-D and the second non-folding display portion NFP2-D may be spaced apart from each other in the first direction DR1 with the folding display portion FP-D interposed therebetween. The folding display portion FP-D may correspond to the folding region FA1 of the electronic device ED, and the first non-folding display portion NFP1-D and the second non-folding display portion NFP2-D may respectively correspond to the first non-folding region NFA1 and the second non-folding region NFA2 of the electronic device ED.

In an embodiment of the invention, the support plate MP may be disposed below the display panel DP. The support plate MP may include a folding support portion FP-MP and non-folding support portions NFP1-MP and NFP2-MP. The first non-folding support portion NFP1-MP and the second non-folding support portion NFP2-MP of the support plate MP may be spaced apart from each other in the first direction DR1 with the folding support portion FP-MP interposed therebetween. The folding support portion FP-MP may correspond to the folding region FA1 (see FIG. 1A), and the non-folding support portions NFP1-MP and NFP2-MP may correspond to the non-folding regions NFA1 and NFA2 (see FIG. 1A). The support plate MP may include a pattern portion PTA in which a plurality of openings OH are defined. The pattern portion PTA may be included in the folding support portion FP-MP. As the pattern portion PTA is disposed to correspond to the folding region FA1, the folding or bending characteristics of the electronic device ED may be improved.

In the display module DM according to an embodiment of the invention, the protective layer PF of the lower module LM may be disposed between the display panel DP and the support plate MP. The protective layer PF may be disposed below the display panel DP to protect the rear surface of the display panel DP. The protective layer PF may entirely overlap the display panel DP. The protective layer PF may include a polymer material. In an embodiment, for example, the protective layer PF may be a polyimide film or a polyethylene terephthalate film. However, this is an example and the material of the protective layer PF is not limited thereto.

In an embodiment of the invention, the lower module LM may include a support member SP. The support member SP may include support layers SP1 and SP2. The support layers SP1 and SP2 may include a first support layer SP1 and a second support layer SP2 spaced apart from each other in the direction of the first directional axis DR1. The first support layer SP1 and the second support layer SP2 may be spaced apart from each other at a portion corresponding to the first folding axis FX1 (see FIG. 1B). In such an embodiment where the support layers SP1 and SP2 are provided as the first support layer SP1 and the second support layer SP2 spaced apart from each other in the folding region FA1, the folding or bending characteristics of the electronic device ED may be improved. In an embodiment, although not illustrated, the support layers SP1 and SP2 may further include a cushion layer (not illustrated) and a lower support plate (not illustrated) which are stacked in the thickness direction.

The electronic device ED according to an embodiment of the invention may further include a digitizer module DTM disposed below the support plate MP. The digitizer module DTM according to an embodiment of the invention may include a digitizer layer, a shielding layer, and the like. The digitizer module DTM may be included in the configuration of the lower module LM.

The digitizer module DTM may include a first digitizer module DTM1 and a second digitizer module DTM2 disposed to be spaced apart from each other in a portion overlapping the folding region FA1. The first digitizer module DTM1 may be disposed to correspond to the first non-folding region NFA1, and the second digitizer module DTM2 may be disposed to correspond to the second non-folding region NFA2.

That is, in an embodiment of the invention, the first digitizer module DTM1 and the second digitizer module DTM2 may be spaced apart from each other in a region overlapping the folding display portion FP-D. The first digitizer module DTM1 may overlap the first non-folding display portion NFP1-D, and the second digitizer module DTM2 may overlap the second non-folding display portion NFP2-D.

In addition, the electronic device ED according to an embodiment of the invention may include at least one selected from adhesive layers AP1, AP2, AP3, and AP4. In an embodiment, for example, a first adhesive layer AP1 may be disposed between the display panel DP and the protective layer PF, and a second adhesive layer AP2 may be disposed between the protective layer PF and the support plate MP. A third adhesive layer AP3 and a fourth adhesive layer AP4 may be disposed between the support plate MP and the support member SP. At least one selected from the adhesive layers AP1, AP2, AP3, and AP4 may be an optically transparent adhesive film or an optically transparent adhesive resin layer. However, the embodiment of the invention is not limited thereto, and at least one of the adhesive layers AP1, AP2, AP3, and AP4 may have a low transmittance of 80% or less.

In FIGS. 4 and 5, etc., an embodiment where the lower module LM includes all of the protective layer PF, the support plate MP, the support member SP, the adhesive layers AP1, AP2, AP3, and AP4, and the digitizer module DTM is illustrated as an example, but the embodiment of the invention is not limited to what is illustrated, and in the configuration of the lower module LM, only some of the listed components may be selected, or components may be added in addition to those presented for the lower module, considering the mechanical properties, shapes, operational characteristics, etc. desired in the electronic device ED.

The electronic device ED according to an embodiment of the invention includes a window module WM disposed on the display module DM. The window module WM may include a folding portion FP-W and non-folding portions NFP1-W and NFP2-W. The first non-folding portion NFP1-W and the second non-folding portion NFP2-W of the window module WM may be spaced apart from each other in the first direction DR1 with the folding portion FP-W interposed therebetween. The folding portion FP-W may correspond to the folding region FA1 of the electronic device ED (see FIG. 1A), and the non-folding portions NFP1-W and NFP2-W may correspond to the non-folding regions NFA1 and NFA2. In addition, the folding portion FP-W may correspond to the folding display portion FP-D, and the non-folding portions NFP1-W and NFP2-W may correspond to the non-folding display portions NFP1-D and NFP2-D.

In an embodiment, the window module WM may entirely cover the upper surface of the display module DM. In an embodiment of the invention, the window module WM may be used as a cover window of the electronic device ED. In an embodiment of the invention, the window module WM may correspond to the uppermost member of the electronic device ED.

In an embodiment of the invention, the window module WM may include a window WP and a resin layer RL. The resin layer RL may be disposed on the upper or lower surface of the window WP. In the drawing of the disclosure, an embodiment where the resin layer RL is disposed on the lower surface of the window WP is illustrated, but the embodiment of the invention is not limited thereto, and the resin layer RL may be disposed on the upper surface of the window WP, or the resin layer RL may be disposed to cover the upper and side surfaces of the window WP.

In an embodiment of the invention, the resin layer RL may include or be formed of an organic resin. In addition, unlike this, the resin layer RL may be formed of a composite resin including both an organic material and an inorganic material.

In an embodiment of the invention, the window WP may be a tempered glass substrate. The window WP may be an ultra-thin tempered glass substrate. The window WP may be flexible enough to change its state easily by folding or bending.

In an embodiment of the invention, the window WP may include a slimming region with an average thickness smaller than that of other portions, and the slimming region may be disposed to correspond to the folding region FA1 of the electronic device. FIG. 5 illustrates the electronic device ED including a single folding region FA1 as an example, but not being limited thereto. In another embodiment where a plurality of folding regions are included therein, the window WP may include slimming regions respectively corresponding to the folding regions. As the slimming region is included in the window WP, the electronic device ED may exhibit excellent folding or bending operation characteristics.

Each of FIG. 6A and FIG. 6B is a cross-sectional view of a window according to an embodiment of the invention. Windows WP and WP-a illustrated in FIGS. 6A and 6B are substantially the same as each other except for the shapes of recessed portions CCP and CCP-a formed in a slimming region SLA.

The window WP or WP-a according to an embodiment of the invention may include a folding portion FP or FP-a and a first non-folding portion NFP1 and a second non-folding portion NFP2 spaced apart from each other in the first direction DR1 with the folding portion FP or FP-a interposed therebetween.

The recessed portion CCP or CCP-a may be a portion formed by being concavely recessed from at least one of the upper or lower surface of the window. The recessed portion CCP or CCP-a may be defined in the folding portion FP or FP-a. In an embodiment, as shown in FIG. 6A and FIG. 6B, the recessed portion CCP or CCP-a of the window WP may be defined or formed in a direction away from the upper surface of the display panel DP, but the embodiment of the invention is not limited thereto, and in another embodiment of the invention, the window WP may be configured in a way such that the recessed portion CCP or CCP-a is concavely recessed in the direction of the display panel DP.

The slimming region SLA, in which the recessed portion CCP or CCP-a is formed, corresponds to a portion that is relatively thinner than the first non-folding portion NFP1 and the second non-folding portion NFP2 of the window. The recessed portion CCP or CCP-a may be formed in a shape that extends in the second direction DR2. The extension direction of the recessed portion CCP or CCP-a may correspond to the extension direction of the folding axis FX1 (see FIG. 4).

An edge portion EDP of the recessed portion CCP or CCP-a, which is the boundary of the slimming region SLA, may be a portion corresponding to a boundary region to which an etching solution is provided in a window manufacturing method according to an embodiment of the invention, which will be described later. In the window WP or WP-a according to an embodiment of the invention, the width and position of the slimming region SLA may be changed according to the folding or bending characteristics desired in the electronic device. The width and position of the slimming region SLA may be controlled according to the position of a nozzle portion configured to supply the etching solution, the supply form of the etching solution, etc. in the window manufacturing device and the window manufacturing method according to an embodiment of the invention, which will be described later.

Referring to FIG. 6A, the recessed portion CCP of the window WP according to an embodiment of the invention may include a curved surface having a predetermined curvature radius (i.e., a radius of curvature). The recessed portion CCP may be a portion having a concavely recessed shape with respect to a flat surface which is the upper surface of the first non-folding portion NFP1 and the second non-folding portion NFP2. The recessed portion CCP may be defined as a continuous curved surface shape extending in the second direction DR2 between the first non-folding portion NFP1 and the second non-folding portion NFP2 spaced apart from each other in the first direction DR1. The upper surface of the exposed recessed portion CCP in the window WP manufactured by the window manufacturing device according to an embodiment of the invention and the window manufacturing method according to an embodiment of the invention, which will be described later, may include a smooth curved surface without a discontinuity or a step difference.

Referring to FIG. 6B, the recessed portion CCP-a of the window WP-a according to an embodiment of the invention may include inclined surfaces SS1 and SS2. The recessed portion CCP-a may be a portion having a concavely recessed shape with respect to a flat surface which is the upper surface of the first non-folding portion NFP1 and the second non-folding portion NFP2. The recessed portion CCP-a may include a recessed-portion flat surface SFP and a first inclined surface SS1 and a second inclined surface SS2 spaced apart from each other in the first direction DR1 with the recessed-portion flat surface SFP interposed therebetween. The recessed-portion flat surface SFP and the inclined surfaces SS1 and SS2 may be defined as a continuous flat and inclined surface shape extending in the second direction DR2. The first inclined surface SS1, the recessed-portion flat surface SFP, and the second inclined surface SS2 may be continuous surfaces without a discontinuity. The first inclined surface SS1, the recessed-portion flat surface SFP, and the second inclined surface SS2 may be adjacent and connected to each other. The boundary portions of the first inclined surface SS1 and the recessed-portion flat surface SFP and the boundary portions of the recessed-portion flat surface SFP and the second inclined surface SS2 may be smoothly connected to each other without a discontinuity or step difference, such that the upper surface of the recessed portion CCP-a may have a continuous surface.

The shapes of the recessed portions CCP and CCP-a of the windows WP and WP-a illustrated in FIGS. 6A and 6B are merely an example, and the shapes of the recessed portions CCP and CCP-a may be changed according to the folding or bending characteristics desired in the electronic device and the like. In an embodiment, for example, depending on the folding or bending characteristics desired in the electronic device, the curvature radius or the like in the recessed portion CCP having a curved shape may be changed, and the inclination angle or length of the inclined surfaces SS1 and SS2 in the recessed portion CCP-a including the inclined surfaces and the width or the like of the recessed-portion flat surface SFP between the inclined surfaces SS1 and SS2 may be changed.

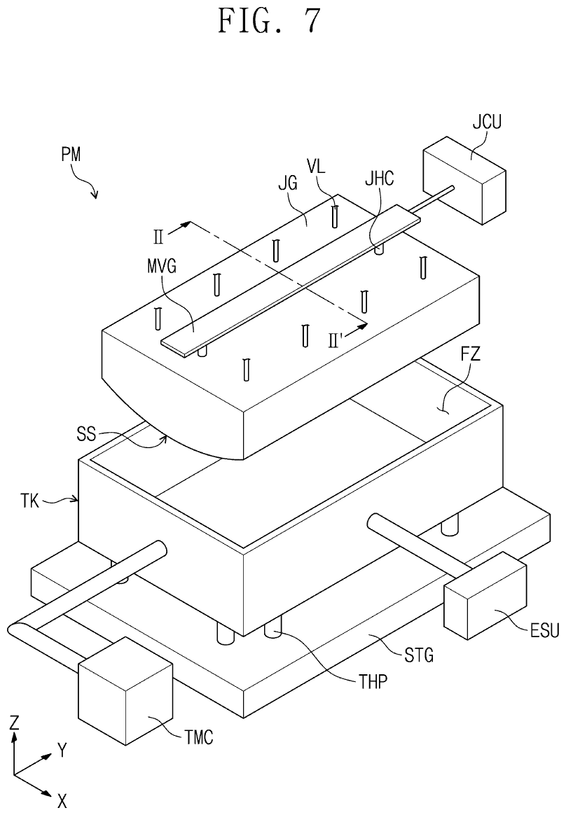

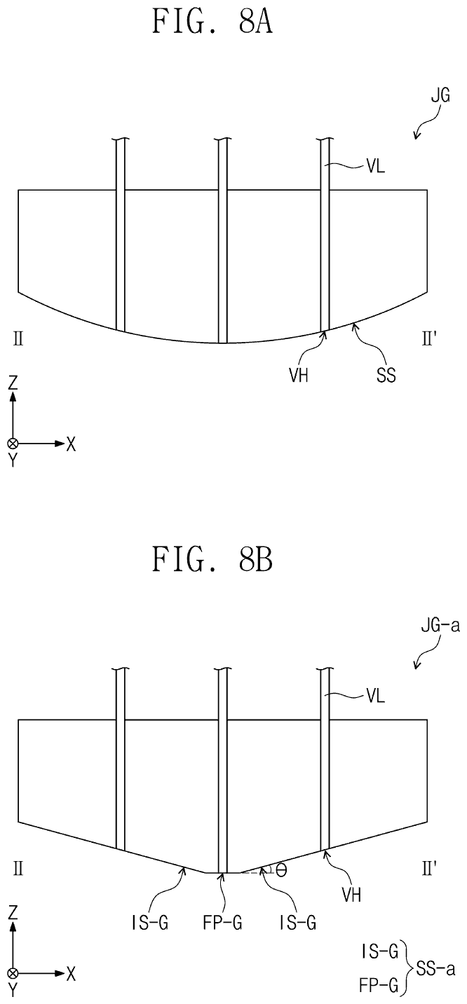

FIG. 7 is a perspective view of a window manufacturing device according to an embodiment of the invention.

The window manufacturing device PM according to an embodiment of the invention may include a fixing jig JG and an etching solution supply part TK disposed below the fixing jig JG. A storage part FZ for storing the etching solution may be defined in the etching solution supply part TK. The etching solution supply part TK may function as a container in which the etching solution supplied during an etching process is stored.

Among an X-axis X, a Y-axis Y, and a Z-axis Z illustrated in FIG. 7 and the drawings below, the Z-axis Z direction is defined as an upward direction. In addition, the X-axis X and the Y-axis Y are orthogonal to each other, and the Z-axis Z may be a normal direction of a plane defined by the X-axis X and the Y-axis Y.

In the disclosure, the X-axis X may correspond to the first direction DR1 illustrated in the drawings described above, the Y-axis Y may correspond to the second direction DR2 illustrated in the drawings described above, and the Z-axis Z may correspond to the third direction DR3 illustrated in the drawings described above.

The fixing jig JG may include a seating surface SS on which a workpiece is fixed. In the fixing jig JG, the seating surface SS on which the workpiece is fixed may include a curved surface or an inclined surface. In particular, the workpiece may be processed by the window manufacturing device PM in a state in which the workpiece is fixed to the curved or inclined surface of the seating surface SS. The curved or inclined surface of the seating surface SS may extend in one direction. Referring to FIG. 7, the curved surface of the seating surface SS may continuously extend in the Y-axis Y direction.

In the disclosure, the workpiece which is processed in the window manufacturing device PM according to an embodiment of the invention may include a base glass. After being processed in the window manufacturing device PM, the base glass may have flexibility and be used as a cover window of the electronic device ED (see FIG. 1A).

In an embodiment of the invention, the fixing jig JG may be connected to a vacuum line VL. The fixing jig JG may be connected to a vacuum pump (not shown) or the like through the vacuum line VL and fix the workpiece by utilizing a state provided through the vacuum line VL.

In the window manufacturing device PM according to an embodiment of the invention, at least a portion of the seating surface SS of the fixing jig JG on which the workpiece is fixed may be accommodated in the storage part FZ of the etching solution supply part TK. In an embodiment of the invention, the size (e.g., a planar area) of the storage part FZ of the etching solution supply part TK may be larger than a size large enough to accommodate at least a portion of the seating surface SS of the fixing jig JG. In the window manufacturing device PM according to an embodiment of the invention, the position of at least one of the fixing jig JG or the etching solution supply part TK may be relatively adjusted in a way such that at least a portion of the seating surface SS of the fixing jig JG is positioned inside the storage part FZ.

In the window manufacturing device PM according to an embodiment of the invention illustrated in FIG. 7, the width of the etching solution supply part TK in the X-axis X direction may be greater than or equal to a width that may accommodate at least a portion of the curved or inclined surface of the seating surface SS of the fixing jig JG, and the width of the etching solution supply part TK in the Y-axis Y direction may be greater than or equal to the width of the fixing jig JG in the Y-axis Y direction.

The window manufacturing device PM according to an embodiment of the invention may further include a plurality of control units for controlling the operation and position of the fixing jig JG and the etching solution supply part TK. The plurality of control units included in the window manufacturing device PM may be simultaneously controlled by a central control unit or may be controlled by respective control systems. It will be understood that the configuration of the control units illustrated and described in FIG. 7 or the like is an example, and in the window manufacturing device PM according to an embodiment of the invention, at least one of the control units to be described later may be omitted, or more control units may be included in addition to those illustrated in FIG. 7.

A jig control unit JCU may control the position and operation of the fixing jig JG. A motion control unit MVG may be connected to the fixing jig JG, and an operation signal provided from the jig control unit JCU may be transmitted to the motion control unit MVG, and the position and operation of the fixing jig JG may be adjusted according to the operation of the motion control unit MVG. The window manufacturing device PM according to an embodiment of the invention may further include a height adjustment unit JHC that additionally adjusts the vertical position of the fixing jig JG. The height adjustment unit JHC may be adjusted by the motion control unit MVG or controlled by a separate control unit. The vertical or horizontal movement of the fixing jig JG may be controlled by the motion control unit MVG and the height adjustment unit JHC, and accordingly, the relative positions of the fixing jig JG, the etching solution stored in the etching solution supply part TK, and the workpiece may be finely adjusted.

Referring to FIG. 7, etc., the vertical direction may correspond to a direction parallel to the Z-axis Z, and the horizontal direction may correspond to a direction parallel to a plane defined by the X-axis X and the Y-axis Y.

The window manufacturing device PM according to an embodiment of the invention may further include a position control unit TMC and a supply control unit ESU for controlling the etching solution supply part TK. The supply control unit ESU may adjust the supply of the etching solution to the storage part FZ of the etching solution supply part TK. Although not illustrated, the supply control unit ESU may be connected to an external etching solution storage device, an etching solution supply line, or the like. The supply control unit ESU may function as a valve for providing the etching solution into the storage part FZ. In addition, the supply control unit ESU may have a level control function that senses and adjusts the level of the etching solution provided into the storage part FZ. The position control unit TMC may control the movement of the etching solution supply part TK in the vertical or horizontal direction.

In the window manufacturing device PM according to an embodiment of the invention, the etching solution provided in the storage part FZ may be provided or stored to be maintained at a certain level during a manufacturing process, or the level of the etching solution may be adjusted over time.

The window manufacturing device PM according to an embodiment of the invention may further include a stage STG on which the etching solution supply part TK is disposed. The etching solution supply part TK may be fixedly disposed on the stage STG. In an embodiment of the invention, the placement position of the etching solution supply part TK may be controlled by being moved in the vertical and horizontal directions in accordance with the movement of the stage STG. A gap adjustment unit THP may be further disposed between the etching solution supply part TK and the stage STG. The gap adjustment unit THP may be adjusted by the position control unit TMC or controlled by a separate control unit. For example, in an embodiment of the invention, the vertical position of the etching solution supply part TK may be finely adjusted by the gap adjustment unit THP.

In the window manufacturing device PM according to an embodiment of the invention illustrated in FIG. 7, the seating surface SS of the fixing jig JG including a curved or inclined surface may be a surface facing the etching solution supply part TK. The window manufacturing device PM according to an embodiment of the invention may be configured in a way such that the seating surface SS of the fixing jig JG has a shape protruding in the direction of the etching solution supply part TK. That is, in the window manufacturing device PM according to an embodiment of the invention, the workpiece may be fixed to the seating surface SS having a shape convexly protruding in the direction toward the etching solution supply part TK.

Each of FIG. 8A and FIG. 8B is a cross-sectional view illustrating a fixing jig according to an embodiment of the invention. Each of FIGS. 8A and 8B may be a cross-sectional view of a fixing jig according to an embodiment of the invention at a portion corresponding to line II-II′ of FIG. 7.

The seating surface SS of the fixing jig JG according to an embodiment of the invention illustrated in FIG. 8A corresponds to having a continuous curved surface shape. The workpiece may be fixed in a deformed form corresponding to the shape of the seating surface SS of the fixing jig JG. That is, the workpiece may be processed by etching an exposed surface thereof in a state of being fixed to have a curved shape. In a window according to an embodiment of the invention manufactured by being fixed to the fixing jig JG according to an embodiment of the invention illustrated in FIG. 8A, the recessed portion of the slimming region SLA may have a continuous curved surface, as illustrated in FIG. 6A.

A fixing jig JG-a according to an embodiment of the invention illustrated in FIG. 8B may have a seating surface SS-a including inclined surfaces IS-G. The seating surface SS-a may include a flat surface FP-G and inclined surfaces IS-G having a predetermined inclination angle Θ with respect to the flat surface FP-G. The inclined surfaces IS-G disposed on both sides with the flat surface FP-G interposed therebetween may have shapes that are symmetrical to each other with respect to the flat surface FP-G. The inclination angle Θ of the inclined surface IS-G may be about 0.1 degree or greater. The inclination angle of the inclined surface in a manufactured window may be determined according to the inclination angle Θ of the inclined surface IS-G.

When a workpiece is disposed on the fixing jig JG-a according to an embodiment of the invention, the workpiece may be fixed in a deformed form corresponding to the shape of the seating surface SS-a defined as the inclined surface IS-G and the flat surface FP-G. That is, the workpiece may be processed by etching an exposed surface thereof in a state of being fixed so as to have a shape including the inclined surface IS-G. In a window according to an embodiment of the invention manufactured by being fixed to the fixing jig JG-a according to an embodiment of the invention as illustrated in FIG. 8B, the recessed portion of the slimming region SLA may have continuous surfaces connected to each other, such as an inclined surface, a flat surface, and an inclined surface, as illustrated in FIG. 6B. The inclined surfaces SS1 and SS2 of the window WP-a manufactured by being fixed to the fixing jig JG-a according to an embodiment of the invention as illustrated in FIG. 8B may be formed to have an inclination angle of about 0.1 degree or greater with respect to the recessed-portion flat surface SFP.

Referring to FIGS. 8A and 8B, a vacuum suction inlet VH may be defined on at least a portion of the seating surface SS or SS-a on which the workpiece is seated. The vacuum suction inlet VH may be connected to the vacuum line VL disposed inside the fixing jig JG and may be a portion defined on the seating surface SS or SS-a. The workpiece may be suctioned and fixed to the fixing jig JG by utilizing a suction state provided by the vacuum suction inlet VH connected to the vacuum line VL.

When a window is manufactured by using the fixing jig JG or JG-a according to an embodiment of the invention illustrated in FIG. 8A or 8B, the window manufacturing device PM (see FIG. 7) according to an embodiment of the invention may be configured to allow the fixing jig having the shape of the seating surface SS or SS-a that reflects the shape of the recessed portion finally desired in the window to be replaced.

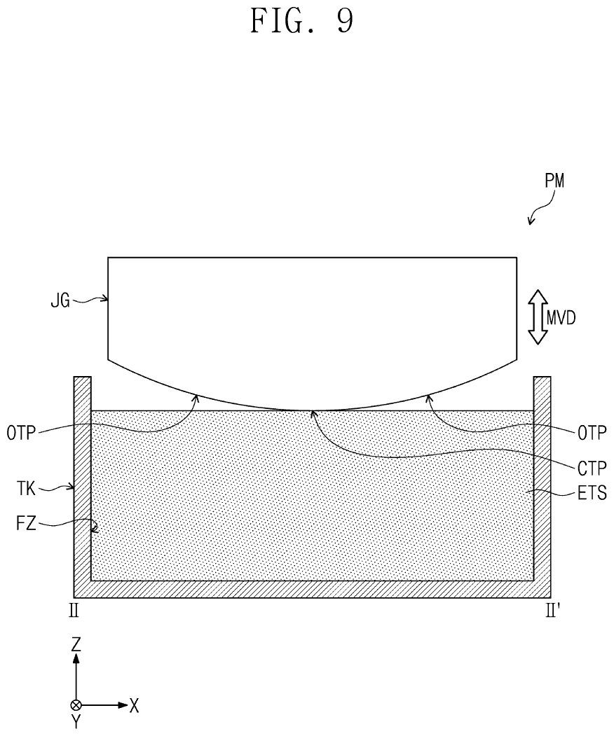

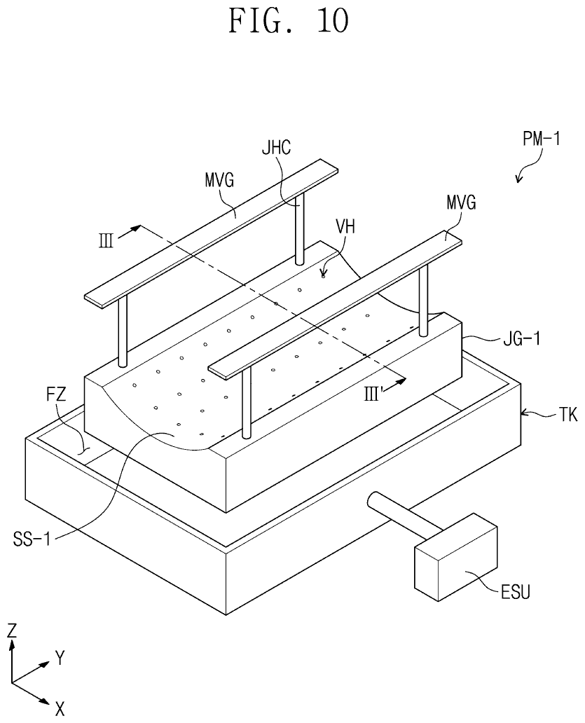

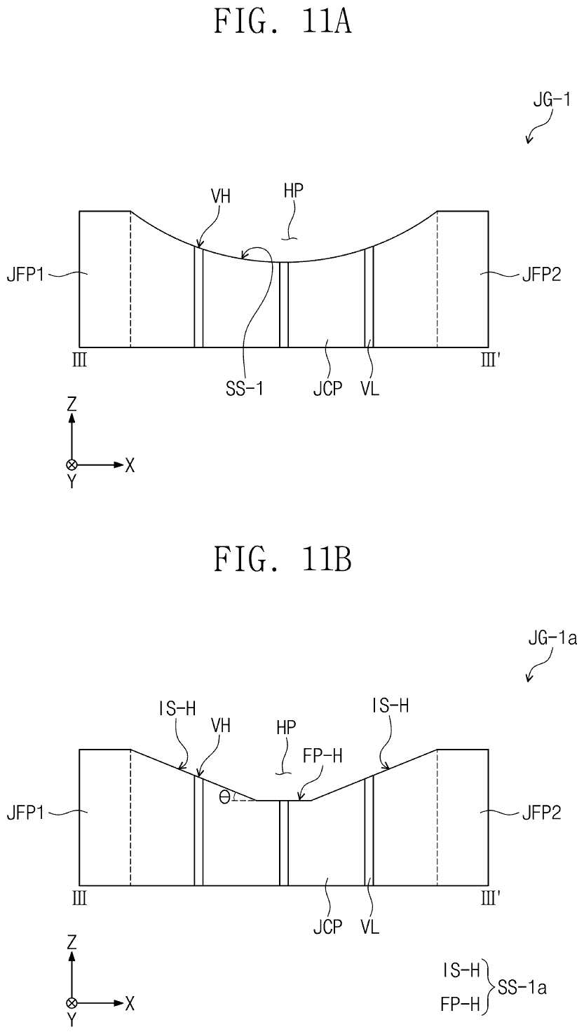

FIG. 9 illustrates a portion of the window manufacturing device according to an embodiment of the invention. FIG. 9 may be a cross-sectional view of a portion of the window manufacturing device, which corresponds to line II-II′ of FIG. 7. FIG. 9 may be a cross-sectional view illustrating an operating state of the window manufacturing device PM according to an embodiment of the invention. FIG. 9 illustrates the window manufacturing device PM including the fixing jig JG illustrated in FIG. 8A, and when the fixing jig JG-a illustrated in FIG. 8B is used, only the fixing jig JG-a may be changed and provided in the window manufacturing device PM illustrated in FIG. 9.

In the window manufacturing device PM according to an embodiment of the invention, an etching solution ETS may be provided to be contained in the storage part FZ of the etching solution supply part TK. The fixing jig JG may be positioned in a way such that the convexly protruding seating surface SS of the fixing jig JG faces the direction of the etching solution ETS. Considering the slimming region of the workpiece fixed to the seating surface SS of the fixing jig JG, the movement of the fixing jig JG may be controlled in an operation direction MVD.

Since the seating surface SS has a convexly curved surface facing the direction of etching solution ETS, a portion of the workpiece fixed to the seating surface SS, which is exposed to the etching solution ETS, may also exhibit differences, based on the shape of the seating surface SS. That is, in an embodiment of the invention, the etching amount of the workpiece fixed to the central portion CTP of the seating surface SS is relatively greater than the etching amount of the workpiece fixed to the outer portion OTP of the seating surface SS.

In an embodiment, in a state of being fixed to the seating surface SS, the workpiece may be immersed in the etching solution ETS, taking into account a portion to be etched, such that the workpiece is exposed to the etching solution ETS without a discontinuity according to the shape of the seating surface SS. Accordingly, the window processed by the window manufacturing device PM according to an embodiment of the invention may have a slimming surface having a recessed portion defined therein and having a smoothly curved surface or slope.

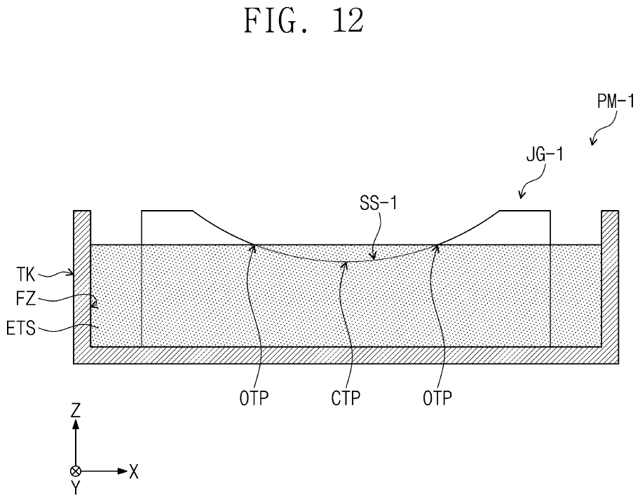

FIG. 10 is a perspective view of a window manufacturing device according to an embodiment of the invention. Each of FIGS. 11A and 11B is a cross-sectional view of a fixing jig according to an embodiment of the invention. FIG. 12 is a cross-sectional view of the window manufacturing device according to an embodiment of the invention. Each of FIG. 11A to FIG. 12 may be a cross-sectional view of a portion corresponding to line III-III′ of FIG. 10.

A window manufacturing device PM-1 according to an embodiment of the invention may include a fixing jig JG-1 including a seating surface SS-1 and an etching solution supply part TK disposed below the fixing jig JG-1. The window manufacturing device PM-1 according to an embodiment of the invention may include a motion control unit MVG configured to control the operation and position of the fixing jig JG-1 and a supply control unit ESU configured to provide an etching solution to the etching solution supply part TK and control the level of the etching solution.

In an embodiment of the invention, the seating surface SS-1 of the fixing jig JG-1 may be spaced apart from the bottom of the storage part FZ of the etching solution supply part TK. The fixing jig JG-1 may include a groove portion HP that is concavely defined in the direction toward the storage part FZ. In an embodiment, as shown in FIGS. 11A and 11B, a portion of the groove portion HP of the fixing jig JG-1 may be defined as the seating surface SS-1. A workpiece may be disposed and fixed to correspond to a seating surface SS-1 or SS-1a of a fixing jig JG-1 or JG-1a.

The groove portion HP of the fixing jig JG-1 may be formed to extend in one direction. Referring to FIG. 10 and FIG. 11A, in the window manufacturing device PM-1 according to an embodiment of the invention, the groove portion HP may be defined in a form that is concavely recessed in the direction toward the storage part FZ and extends in the Y-axis Y direction. A portion to be processed as a slimming region in the base glass provided as a workpiece may be disposed in the groove portion HP of the fixing jig JG-1.

Referring to FIGS. 11A and 11B, the fixing jig JG-1 or JG-1a may be divided into a processing portion JCP including a groove portion HP and a first support portion JFP1 and a second support portion JFP2 spaced apart from each other in the X-axis X direction, which is one direction, with the processing portion JCP interposed therebetween. The upper surface of the fixing jig JG-1 or JG-1a may include a flat surface and a curved surface or an inclined surface.

The upper surface of the processing portion JCP includes a curved surface or an inclined surface, and the upper surfaces of the first support portion JFP1 and the second support portion JFP2 may be flat surfaces. The groove portion HP of the fixing jig JG-1 or JG-1a may include a curved surface having a curvature, or an inclined surface formed to have an inclination angle, based on a flat surface which is the upper surface of the first support portion JFP1 or the second support portion JFP2. The workpiece may be provided to the groove portion HP of the fixing jig JG-1 or JG-1a in a shape that is deformed to have a curvature or a predetermined angle and fixed to have a shape corresponding to the shape of the seating surface SS-1 or SS-1a defining the groove portion HP of the fixing jig JG-1 or JG-1a.

The seating surface SS-1 of the fixing jig JG-1 according to an embodiment of the invention illustrated in FIG. 11A has a continuous curved surface shape. The workpiece may be fixed in a deformed shape according to the shape of the seating surface SS-1, which is one surface defining the groove portion HP. That is, the workpiece may be processed by etching an exposed surface in a state of being fixed to have a curved surface shape. The recessed portion of the slimming region SLA of the window according to an embodiment of the invention manufactured by being fixed to the fixing jig JG-1 according to an embodiment of the invention as illustrated in FIG. 11A may have a continuous curved surface as illustrated in FIG. 6A.

The seating surface SS-1a of the fixing jig JG-1a according to an embodiment of the invention as illustrated in FIG. 11B may include inclined surfaces IS-H. The seating surface SS-1a may include a flat surface FP-H and inclined surfaces IS-H having a predetermined inclination angle Θ with respect to the flat surface FP-H. The inclined surfaces IS-H disposed on both sides with the flat surface FP-H interposed therebetween may have shapes that are symmetrical to each other with respect to the flat surface FP-H. The inclination angle Θ of the inclined surface IS-H may be about 0.1 degree or greater. The inclination angle of the inclined surface in a manufactured window may be determined in accordance with the inclination angle Θ of the inclined surface IS-H.

When the workpiece is disposed on the fixing jig JG-1a according to an embodiment of the invention, the workpiece may be fixed in a deformed shape corresponding to the shape of the seating surface SS-1a, which is the upper surface of the groove portion defined as the inclined surface IS-H and the flat surface FP-H. That is, the workpiece may be processed by etching an exposed surface in a state of being fixed to have a shape including the inclined surface IS-H. In a window according to an embodiment of the invention manufactured by being fixed to the fixing jig JG-1a according to an embodiment of the invention illustrated in FIG. 11B, the recessed portion of the slimming region SLA may have continuous surfaces connected to each other, such as an inclined surface, a flat surface, and an inclined surface, as illustrated in FIG. 6B. The inclined surfaces SS1 and SS2 of the window WP-a manufactured by being fixed to the fixing jig JG-1a may be formed to have an inclination angle of about 0.1 degree or greater with respect to the flat surface SFP of the recessed portion.

Referring to FIGS. 11A and 11B, the vacuum suction inlet VH may be defined on the seating surface SS-1 or SS-1a, which is one surface of the groove portion HP on which the workpiece is seated. The vacuum suction inlet VH may be connected to the vacuum line VL disposed inside the fixing jig JG-1 or JG-1a and may be defined on the seating surface SS-1 or SS-1a. Although not illustrated, the vacuum line VL may be connected to a vacuum pump or the like to suction and fix the workpiece seated on the fixing jig JG-1 and JG-1a.

The fixing jigs illustrated in FIGS. 11A and 11B may have the groove portion HP with a fixed shape. When the window is manufactured by using the fixing jig JG-1 or JG-1a according to an embodiment of the invention illustrated in FIGS. 11A and 11B, in the window manufacturing device PM-1 according to an embodiment of the invention, a fixing jig with a groove portion that reflects the shape of the recessed portion in the window may be replaced as desired.

FIG. 12 may be a cross-sectional view illustrating one operating state of the window manufacturing device according to an embodiment of the invention. In the window manufacturing device PM-1 according to an embodiment of the invention, the fixing jig JG-1 may be inserted and positioned within the storage part FZ of the etching solution supply part TK. That is, the area (e.g., a planar area) of the storage part FZ defined by the X-axis X and the Y-axis Y may be larger than an area capable of accommodating the entire fixing jig JG-1.

In one operating state of the window manufacturing device according to an embodiment of the invention, the fixing jig JG-1 may be inserted and fixedly positioned in the storage part FZ, and the level of the etching solution ETS supplied to the storage part FZ may be adjusted. According to the adjustment of the level of the etching solution ETS, the range of the slimming region corresponding to a portion of the workpiece to be etched and the amount of etching within the slimming region may be adjusted.

In the window manufacturing device PM-1 according to an embodiment of the invention, the fixing jig JG-1a may be positioned in the storage part FZ so that the flat surface FP-H of the seating surface SS-1a and at least a portion of the inclined surfaces IS-H adjacent to the flat surface FP-H are immersed in the etching solution ETS supplied to the storage part FZ. As the seating surface SS-1 is immersed in the etching solution ETS, differences appear in even a portion of the workpiece fixed to the seating surface SS-1, which is exposed to the etching solution ETS, depending on the shape of the seating surface SS-1.

In an embodiment of the invention, the fixing jig JG-1 may be positioned so that at least a portion of the seating surface SS-1 of the concave groove portion HP of the fixing jig JG-1 is immersed in the etching solution ETS, and the level of the etching solution ETS provided in the storage part FZ may be adjusted in consideration of the slimming region of the workpiece fixed to the seating surface SS-1 of the fixing jig JG-1. By adjusting the level of the etching solution ETS over time, the amount of etching varies depending on the placement position of the workpiece disposed on the seating surface SS-1.

In an embodiment of the invention, the etching amount of the workpiece fixed to the central portion CTP of the seating surface SS-1 defining the groove portion HP concavely defined toward the bottom surface of the storage part FZ is relatively greater than the etching amount of the workpiece fixed to the outer portion OTP of the seating surface SS-1 according to the adjustment of the level of the etching solution ETS over time. In addition, by considering the degree of etching and ensuring that an entire portion requiring etching is immersed in the etching solution ETS in a state in which the workpiece is fixed to the seating surface SS-1, it is possible to expose the workpiece to the etching solution ETS without any discontinuity according to the shape of the seating surface SS-1. Accordingly, the window processed in the window manufacturing device PM-1 according to an embodiment of the invention may have a slimming surface with a recessed portion defined therein and having a smoothly curved surface or slope.

When using the window manufacturing device according to an embodiment of the invention described with reference to FIGS. 7 to 11B to process a base glass using the etching solution, a separate pre-treatment masking process for distinguishing a portion to which the etching solution is provided and a separate post-processing process such as surface polishing after etching may be omitted. In addition, when using the window manufacturing device according to an embodiment of the invention, a step difference or discontinuity that may occur at a boundary between a portion to which the etching solution is provided and a portion to which the etching solution is not provided or at a boundary between a portion to which a large amount of etching is provided and a portion to which a small amount of etching is provided does not occur, such that a window manufactured using the window manufacturing device according to an embodiment of the invention may exhibit improved surface quality characteristics without any discontinuity.

When manufacturing a window using the window manufacturing device according to an embodiment of the invention, the flexibility of an ultra-thin tempered glass used as a base glass may be used to bend or transform the base glass into a curved state to correspond to the shape of the fixing jig prior to etching, so that the overall thickness of the window may be increased and the thickness of the folding portion of the window may be easily reduced in a desired shape. Accordingly, the window manufactured using the window manufacturing device according to an embodiment of the invention may exhibit high durability while having improved surface quality characteristics.

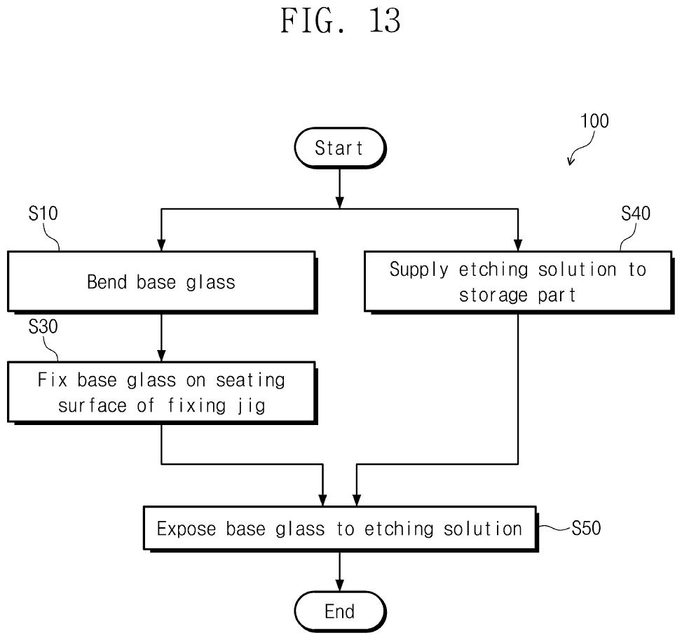

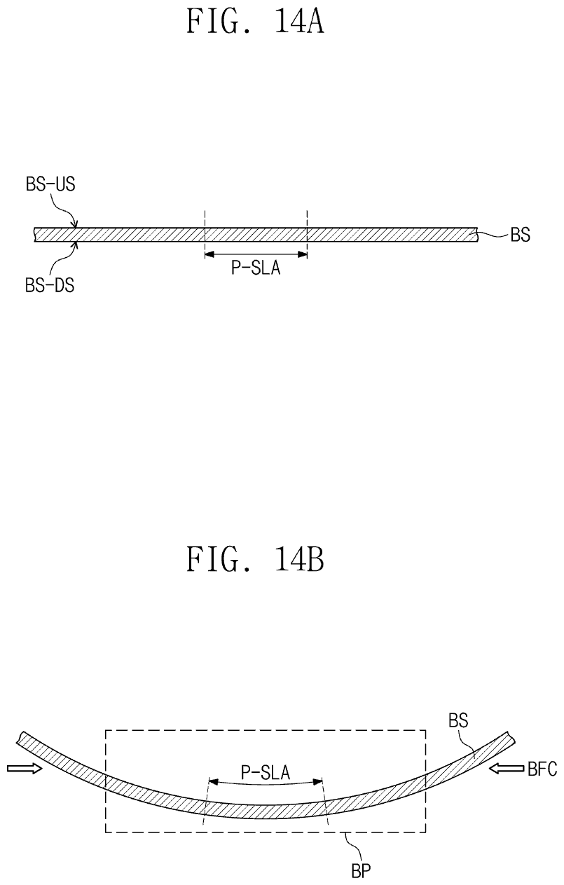

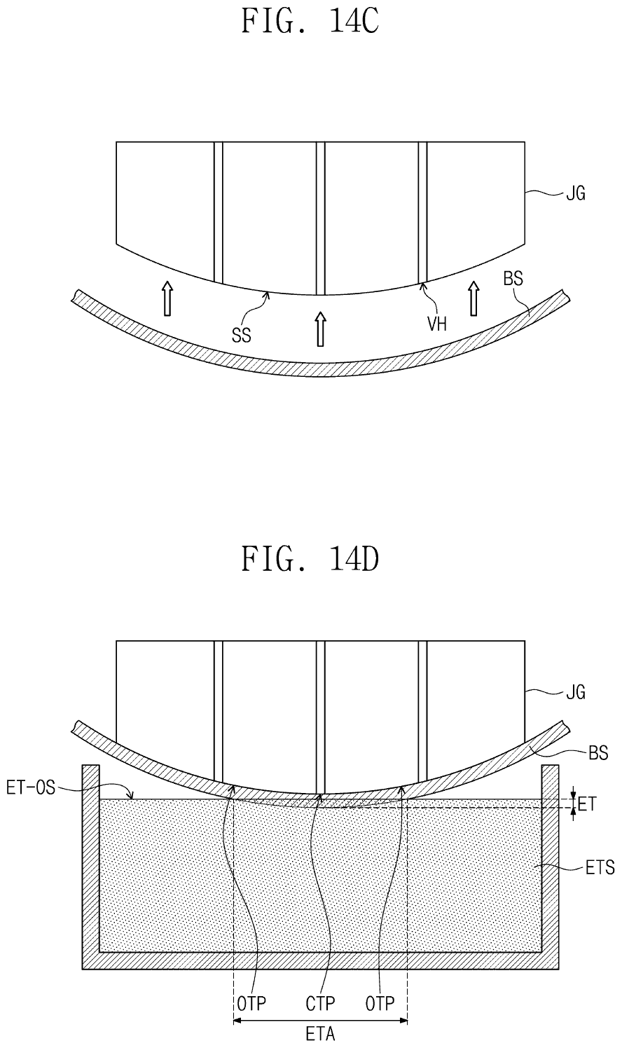

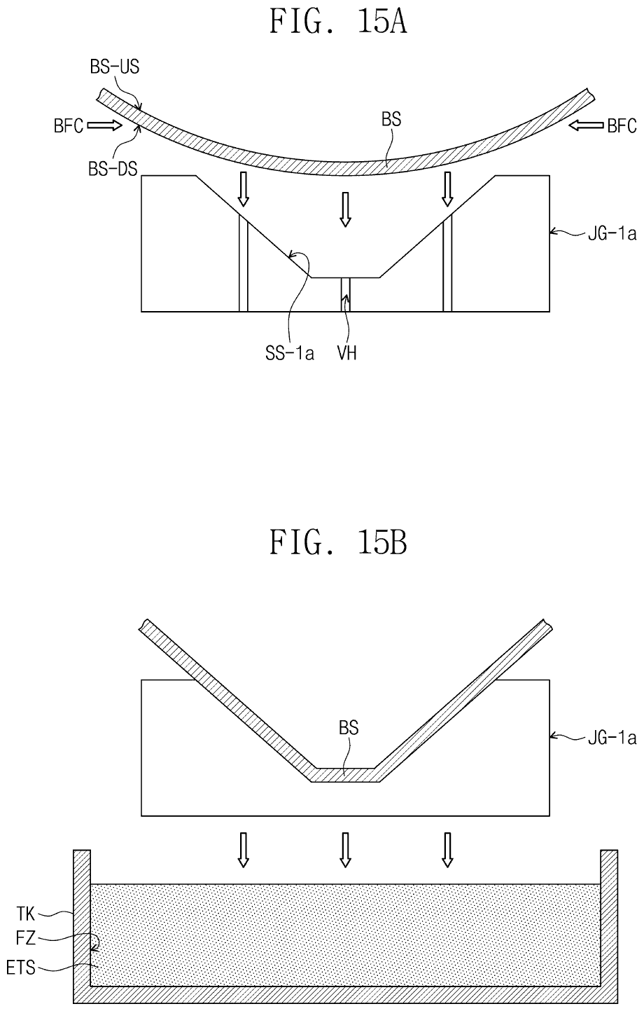

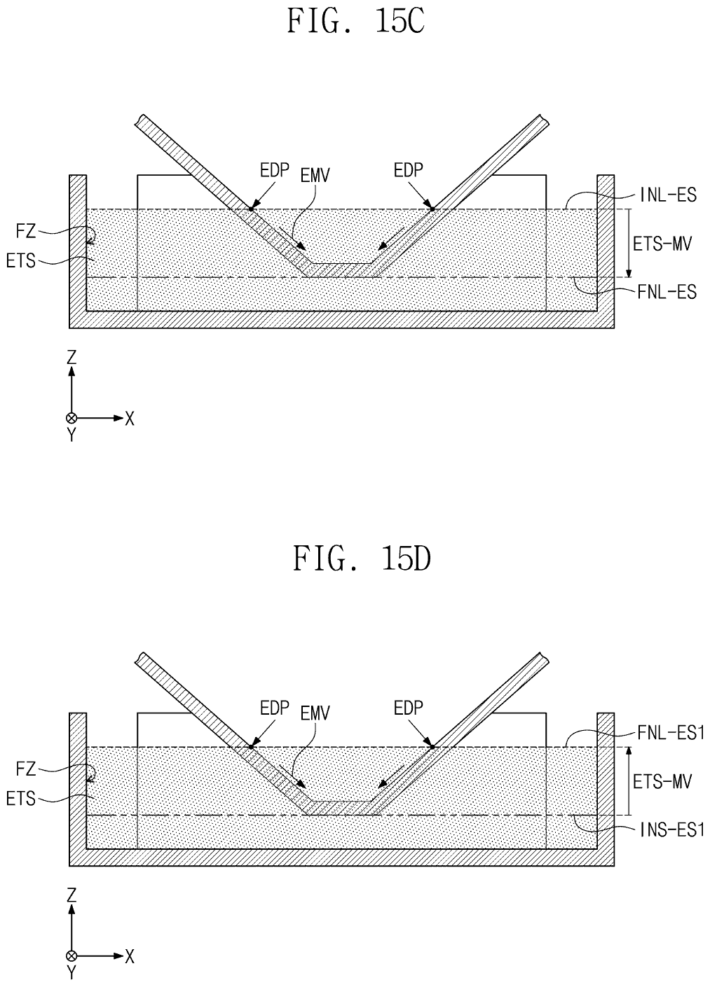

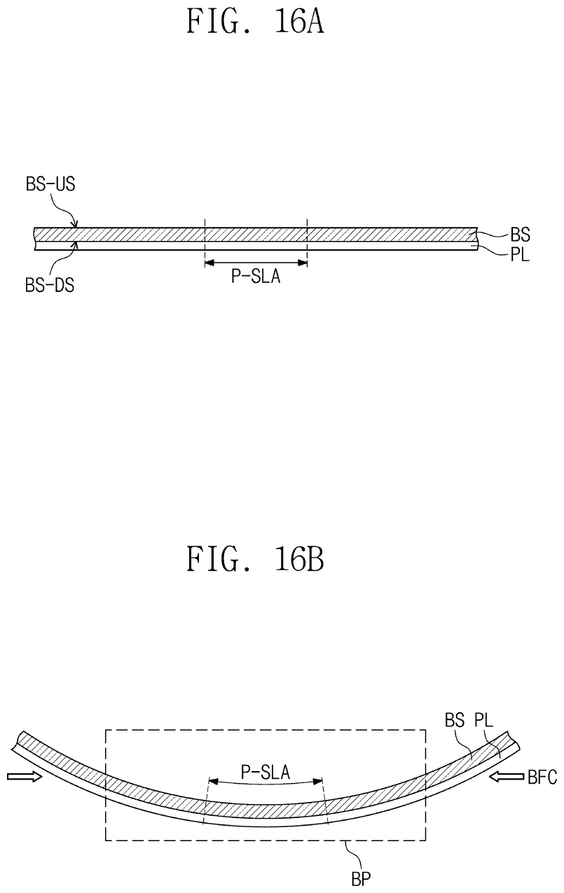

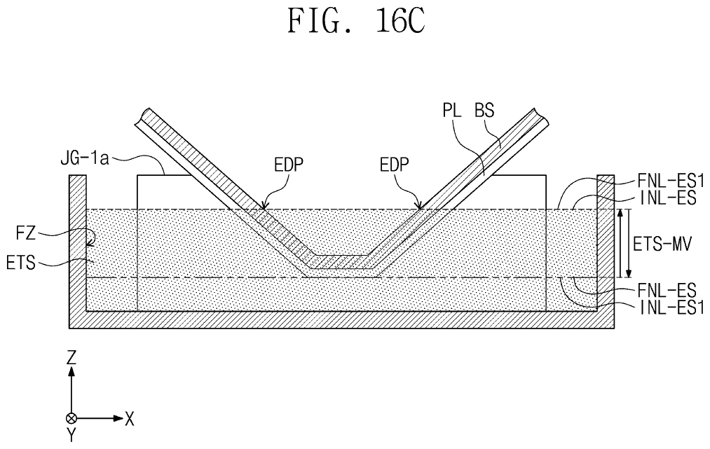

FIG. 13 is a flowchart of a window manufacturing method according to an embodiment of the invention. Each of FIGS. 14A to 16C illustrates a process of the window manufacturing method according to an embodiment of the invention. Hereinafter, in the descriptions of the window manufacturing method according to an embodiment of the invention described with reference to FIGS. 13 to 16C, any repetitive detailed description of the same or like elements as those described above will be omitted and different features will be mainly described.

The window manufacturing method 100 according to an embodiment of the invention may include bending a base glass (S10), fixing the base glass to a seating surface of a fixing jig (S30), and exposing the base glass to an etching solution (S50). In addition, the window manufacturing method 100 according to an embodiment of the invention may include supplying the etching solution to a storage part of an etching solution supply part (S40).

The supplying of the etching solution (S40) may be performed before the exposing of a portion of the base glass to the etching solution (S50). The supplying of the etching solution (S40) may be performed sequentially after the fixing of the base glass to the seating surface of the fixing jig (S30), or the supplying of the etching solution (S40) may be performed as a process separate from the bending of the base glass (S10) and/or the fixing of the base glass to the seating surface of the fixing jig (S30), and the supplying of the etching solution (S40) may be performed independently of other processes. The supplying of the etching solution (S40) may include filling a predetermined amount of the etching solution into the storage part of the etching solution supply part. In an embodiment, the supplying of the etching solution may be performed after the base glass fixed to the fixing jig is disposed adjacent to the storage part, or after the fixing jig on which the base glass is seated is fixed within the storage part. In another embodiment, the etching solution may be supplied to and filled in the storage part first, and then the position of the fixing jig or the etching solution supply part may be adjusted such that the fixing jig is disposed adjacent to the etching solution or the fixing jig is immersed in the etching solution.

The window manufacturing method 100 according to an embodiment of the invention may be a method of manufacturing a window using the window manufacturing device according to an embodiment of the invention illustrated in FIGS. 7 to 12. The window manufacturing method 100 according to an embodiment of the invention may be a method of manufacturing a window using the window manufacturing device including a fixing jig including a seating surface including a curved or inclined surface, and an etching solution supply part with a storage part defined therein, disposed below the fixing jig, and accommodating at least a portion of the seating surface.

In the window manufacturing method 100 according to an embodiment of the invention, the bending of the base glass (S10) may include bending the base glass to include a bending portion having a shape corresponding to the seating surface of the window manufacturing device. In addition, the fixing of the base glass to the seating surface of the fixing jig may include fixing the bent base glass to the fixing jig in a way such that the bending portion is disposed in a shape corresponding to the shape of the seating surface of the fixing jig.

The exposing of one surface of the base glass to the etching solution (S50) may include providing the etching solution to one exposed surface that is not attached to the seating surface of the fixing jig. One exposed surface of the base glass corresponding to the shape of the fixing jig may be exposed to the etching solution contained in the etching solution supply part. In such an embodiment, the gap between the fixing jig and the etching solution supply part in the vertical direction may be adjusted in a way such that the fixing jig is not exposed to the etching solution. Alternatively, by disposing the fixing jig, to which the base glass is fixed, inside the storage part of the etching solution supply part, one surface of the base glass may be exposed to the etching solution and a portion of the fixing jig may also be exposed to the etching solution.

The exposing of the base glass to the etching solution (S50) may include controlling the degree of etching by the etching solution based on the position of the exposed surface of the base glass to form a window with a recessed portion defined therein. In addition, the exposing of the base glass to the etching solution (S50) may include controlling the time of exposure to the etching solution or the amount of the etching solution provided based on the position of the exposed surface of the base glass.

The processes of the window manufacturing method according to an embodiment of the invention illustrated and described with reference to FIGS. 14A to 14C may correspond to the manufacturing method using the window manufacturing device according to an embodiment of the invention described with reference to FIGS. 7 to 9.

FIG. 14A is a cross-sectional view of a base glass processed using the window manufacturing method according to an embodiment of the invention. The base glass BS is a tempered glass substrate and may have flexibility that allows easy bending.

The base glass BS includes an upper surface BS-US and a lower surface BS-DS facing each other, and each of the upper surface BS-US and the lower surface BS-DS may be a flat surface. The base glass BS may include at least one preliminary slimming region P-SLA. The preliminary slimming region P-SLA may be a portion to be processed into the slimming region SLA (see FIGS. 6A and 6B) of the window.

FIG. 14B illustrates the bending of the base glass (S10).

The base glass BS may be bent to include a bending portion BP before being provided to the fixing jig such that the base glass BS may be easily disposed according to the shape of the seating surface of the fixing jig. In the bending of the base glass S10, an external force BFC may be applied to the base glass BS such that the base glass BS is deformed into a shape including the bending portion BP. The base glass BS may be bent in a way such that the bending portion BP includes the preliminary slimming region P-SLA.

FIG. 14C illustrates the fixing of the base glass to the seating surface of the fixing jig (S30) in the window manufacturing method according to an embodiment of the invention. As illustrated in FIG. 14C, in the fixing of the base glass to the seating surface (S30), the bending portion BP of the base glass BS may be disposed to correspond to the seating surface SS of the fixing jig JG. The bending portion BP of the base glass BS may be disposed in a deformed shape corresponding to the shape of the seating surface SS and fixed to the fixing jig JG. In an embodiment, in the fixing of the base glass to the seating surface of the fixing jig (S30), the remaining portion of the base glass BS, excluding the preliminary slimming portion P-SLA, may be spaced apart from one surface of the fixing jig JG without being in contact therewith.

The base glass BS may be fixed in a shape corresponding to the shape of the seating surface SS by using a vacuum state provided through the vacuum suction inlet VH defined on the seating surface SS and connected to the vacuum line VL. The fixing of the base glass to the seating surface of the fixing jig (S30) may include suctioning and fixing one surface of the base glass BS through the vacuum suction inlet VH.

That is, unlike a conventional manufacturing method in which a base glass BS is provided in an unfolded state and disposed on the jig for an etching process, the window manufacturing method according to an embodiment of the invention may bend the base glass BS to include the preliminary slimming region P-SLA and fix the base glass BS to the fixing jig JG to maintain the bent shape. Accordingly, compared to the conventional process in which a separate masking process is performed as a pre-treatment process to distinguish a portion to be etched from other portions, the window manufacturing method according to an embodiment of the invention may omit the pre-treatment process by bending a base glass and fixing the base glass to the seating surface of the fixing jig that reflects the shape of the slimming region desired in a finally manufactured window.

FIG. 14D illustrates the exposing of the base glass to the etching solution (S50) in the window manufacturing method according to an embodiment of the invention. One exposed surface of base glass BS fixed to the fixing jig JG is exposed to the etching solution ETS, and the thickness of base glass BS exposed to the etching solution ETS may vary continuously according to the shape of the seating surface SS. That is, the thickness of base glass BS fixed to the fixing jig JG, which is exposed to the etching solution ETS, may gradually decrease from the central portion CTP of the seating surface SS toward the outer portion OTP. The etching amount of base glass BS may be the greatest at a portion fixed to correspond to the central portion CTP of the fixing jig JG, and the amount of etching may gradually decrease from the central portion CTP toward the outer portion OTP.

In FIG. 14D, a region ETA exposed to the etching solution may correspond to the slimming region SLA (see FIG. 6A). In FIG. 14D, the maximum thickness portion of the base glass BS immersed in the etching solution may correspond to an etching thickness ET. The etching thickness ET may correspond to a depth t_{CCP} (see FIG. 6A) of the recessed portion. The edge portion EDP of the base glass BS corresponding to the level of a surface ET-OS of the etching solution ETS may correspond to the edge portion EDP (see FIG. 6A) of the slimming region.

In a window manufactured in one process of the window manufacturing method according to an embodiment of the invention illustrated in FIGS. 14A to 14D, a concavely recessed portion CCP may be defined in the slimming region SLA as illustrated in FIG. 6A, etc., and one exposed surface of the recessed portion CCP may have a curved surface shape without a discontinuity.

When the fixing jig JG-a according to an embodiment of the invention illustrated in FIG. 8B is used for processes of the window manufacturing method according to an embodiment of the invention illustrated in FIGS. 14C and 14D, a window where a concavely recessed portion CCP-a is defined in the slimming region SLA as illustrated in FIG. 6B, and one exposed surface of the recessed portion CCP-a includes a flat surface and inclined surfaces without a discontinuity and have a smooth slope shape at the boundary portion may be manufacture.

Each of FIGS. 15A to 15D illustrates a process of the window manufacturing method according to an embodiment of the invention. The processes of the window manufacturing method according to an embodiment of the invention illustrated and described with reference to FIGS. 15A to 15D may correspond to the manufacturing method using the window manufacturing device according to an embodiment of the invention described with reference to FIGS. 10 to 12. FIGS. 15A to 15D illustrate the window manufacturing method using the window manufacturing device including the fixing jig illustrated in FIG. 11B, but the window manufacturing method according to an embodiment of the invention described with reference to FIGS. 15A to 15D may be equally applied to the window manufacturing method using the window manufacturing device including the fixing jig illustrated in FIG. 11A.

FIG. 15A illustrates the bending of the base glass (S10) and the fixing of the base glass to the seating surface of the fixing jig. The base glass BS may be deformed by an external force BFC to correspond to the shape of the seating surface SS-1a of the fixing jig JG-1a. The base glass BS may have flexibility that allows its shape to be easily deformed by the external force BFC. The base glass BS may be seated on the fixing jig JG-1a in a state of being partially bent by the external force BFC and fixed by being suctioned by the vacuum suction inlet VH.

FIG. 15B and FIG. 15C illustrate the exposing of the base glass to the etching solution (S50). The fixing jig JG-1a may be accommodated inside the storage part FZ in a state in which the base glass BS is fixed. In an embodiment of the invention, the level of the etching solution may be changed over time in a state in which the base glass BS is exposed to the etching solution ETS of the storage part FZ.

The level of the etching solution may be changed in a direction ETS-MV that gradually decreases from an initial state INL-ES to a final state FNL-ES. In addition, the etching solution ETS flows in a flow direction EMV along the slope of the base glass BS. Accordingly, the exposure time of the central portion of the base glass BS to the etching solution becomes longer, resulting in a greater amount of etching in the central portion of the base glass BS, compared to other portions exposed to the etching solution. In a process of the manufacturing method illustrated in FIG. 15C, the edge portion EDP may be determined based on the position of the initial state INL-ES of the etching solution. In FIG. 15C, the edge portion EDP to which the etching solution ETS is first provided may correspond to the edge portion EDP (see FIG. 6B) of the slimming region of the manufactured window.

Referring to FIG. 15D, in an embodiment of the invention, after the fixing jig JG-1a is accommodated inside the storage part FZ in a state in which the base glass BS is fixed, the level of the etching solution may be changed in a direction ETS-MV that gradually increases from an initial state INL-ES1 to a final state FNL-ES1. In such an embodiment, the etching solution ETS flows in the flow direction EMV along the slope of the base glass BS. Accordingly, the exposure time of the central portion of the base glass BS to the etching solution ETS becomes longer, and the amount of etching solution provided to the central portion also increases, resulting in a greater amount of etching in the central portion of the base glass BS, compared to other portions exposed to the etching solution. In a process of the manufacturing method illustrated in FIG. 15D, the edge portion EDP may be determined according to the position of the final state FNL-ES1 of the etching solution. In FIG. 15D, the edge portion EDP to which the etching solution ETS is finally provided may correspond to the edge portion EDP (see FIG. 6B) of the slimming region of the manufactured window.

In a window manufactured by being exposed to the etching solution by the method illustrated in FIG. 15C or FIG. 15D, a concavely recessed portion CCP-a may be defined in the slimming region SLA as illustrated in FIG. 6B, and one exposed surface of the recessed portion CCP-a may include a flat surface and inclined surfaces without a discontinuity and have a smooth slope shape at the boundary portion.

Meanwhile, when the fixing jig JG-1 according to an embodiment of the invention illustrated in FIG. 11A is used in one process of the window manufacturing method according to an embodiment of the invention illustrated in FIG. 15C and FIG. 15D, in the window manufactured in one process of the window manufacturing method according to an embodiment of the invention, a concavely recessed portion CCP may be defined in the slimming region SLA as illustrated in FIG. 6A, and one exposed surface of the recessed portion CCP may have a shape including a curved surface without a discontinuity.

In addition, in the case of the window manufacturing method according to an embodiment of the invention described with reference to FIGS. 15A to 15D, compared to a conventional manufacturing method that must perform a separate masking process as a pre-treatment process to distinguish a portion requiring etching from other portions, the pre-treatment process may be omitted by bending the base glass and fixing it on the seating surface of the fixing jig that reflects the shape of the slimming region desired in the finally manufactured window and exposing the base glass to the etching solution to form the slimming region. In addition, by accommodating the entire fixing jig, to which the base glass is fixed, in the storage part and controlling the level of the etching solution in consideration of the slimming region, it is possible to easily manufacture a window with recessed portions having different degrees of etching in a single process without an additional process.

FIGS. 16A to 16C illustrate processes of the window manufacturing method according to an embodiment of the invention. The window manufacturing method according to an embodiment of the invention described with reference to FIGS. 16A to 16C is substantially the same as the window manufacturing method according to an embodiment of the invention described with reference to FIGS. 15A to 15D except that a protective film PL is attached to one surface of the window.

Referring to FIG. 16A, the protective film PL may be attached to one surface BS-DS of the base glass BS. The protective film PL may be provided on a surface other than the surface BS-US that is slimmed in the base glass BS. In an embodiment, the protective film PL may be provided on the entire one surface BS-DS of the base glass BS, or may be provided only on a region of the base glass BS that is exposed to the etching solution.

FIG. 16B illustrates the bending of the base glass (S10) (see FIG. 13). The base glass BS may be bent by an external force BFC in a state in which the protective film PL is attached. The protective film PL may have sufficient adhesive strength such that the protective film PL is not peeled off from the base glass BS even when the base glass BS is bent and deformed by the external force BFC to form a bending portion BP.

FIG. 16C illustrates the exposing of the base glass to an etching solution (S50) (see FIG. 13). FIG. 16C illustrates the method of providing the etching solution, as illustrated and described in FIGS. 15C and 15D, in a single drawing. The movement direction ETS-MV of the level of the etching solution ETS may be a direction in which the level decreases from the initial state INL-ES to the final state FNL-ES, or a direction in which the level increases from the initial state INL-ES1 to the final state FNL-ES1. As described with reference to FIGS. 15C and 15D, in the case of the window manufactured by the window manufacturing method according to an embodiment of the invention described with reference to FIGS. 16A to 16C, a concavely recessed portion CCP-a may be defined in the slimming region SLA as illustrated in FIG. 6B, and one exposed surface of the recessed portion CCP-a may include a flat surface and inclined surfaces without a discontinuity and have a smooth slope shape at the boundary portion. In addition, in the case of the window manufactured by the window manufacturing method according to an embodiment of the invention according to a change in the fixing jig JG-1a, a concavely recessed portion CCP may be defined in the slimming region SLA as illustrated in FIG. 6A, and one exposed surface of the recessed portion CCP may include a curved surface without a discontinuity.

In addition, in the case of the window manufacturing method according to an embodiment of the invention described with reference to FIGS. 16A to 16C, by accommodating the entire fixing jig, to which the base glass is fixed, in the storage part and controlling the level of the etching solution in consideration of the slimming region, it is possible to easily manufacture a window with recessed portions having different degrees of etching in a single process without an additional process. In addition, while the base glass is exposed to the etching solution, the other surface of the base glass, for which slimming is undesired, is protected by the protective film, thereby preventing damage to the base glass due to the etching solution. Accordingly, it is possible to improve the quality of the window manufactured by the window manufacturing method according to an embodiment of the invention.

In the descriptions of the manufacturing device according to an embodiment of the invention and the manufacturing method according to an embodiment of the invention described with reference to FIGS. 7 to 16C, the manufacturing method of the window corresponding to the form of the electronic device illustrated in FIG. 1A and the like is mainly described, but the embodiment of the invention is not limited thereto, and the manufacturing device according to an embodiment of the invention and the manufacturing method according to an embodiment of the invention may also be used to manufacture a window including a plurality of folding portions and a window having various shapes of folding portions.

In the case of the window manufacturing method according to an embodiment of the invention, when the base glass is processed using an etching solution, a separate pre-treatment masking process for distinguishing a portion to which the etching solution is provided and a separate post-processing process such as surface polishing after etching may be omitted. Accordingly, process efficiency may be improved by the window manufacturing method according to an embodiment of the invention. In addition, when the window manufacturing method according to an embodiment of the invention is used, a step difference or discontinuity that may occur at the boundary between a portion to which the etching solution is provided and a portion to which it is not provided does not occur, such that the surface of the manufactured window may exhibit improved quality characteristics without a discontinuity. Accordingly, in the case of the electronic device that includes the window manufactured by the window manufacturing device according to an embodiment of the invention or the window manufacturing method according to an embodiment of the invention, issues such as image distortion or stain recognition that may occur at a discontinuity may be improved, thus exhibiting high display quality.

In addition, when a window is manufactured using the window manufacturing method according to an embodiment of the invention, by performing the bending of the base glass into a bent or curved state with the use of the flexibility of the ultra-thin tempered glass used as a base glass, fixing the base glass in a bent form to match the shape of the seating surface of the fixing jig, and then exposing the base glass to an etching solution, the thickness of a portion that is not desired to be etched may be maintained at a sufficient thickness. Therefore, when a window is manufactured using the window manufacturing method according to an embodiment of the invention, the overall thickness of the window corresponding to the non-folding portion may be increased, and the thickness of a portion of the window corresponding to the folding portion may be easily reduced in a desired form. Accordingly, the window manufactured using the window manufacturing method according to an embodiment of the invention may exhibit high durability while having high surface quality characteristics.

The window manufacturing device according to an embodiment of the invention may be used to manufacture a window with excellent surface quality by controlling the position at which a workpiece fixed to a fixing jig with a curved or oblique surface is exposed to an etching solution and the time for which the workpiece is exposed to the etching solution, in consideration of the shape of the recessed portion of the slimming region required in the window.

The window manufacturing method according to an embodiment of the invention may provide a window having a desired recessed portion shape and improved surface quality without a discontinuity on the surface of the recessed portion by controlling the position at which an etching solution is provided and the time for which the workpiece is exposed to the etching solution in a process step.

In addition, the window manufacturing device and the window manufacturing method according to an embodiment of the invention may improve process economy as a pre-treatment process and a post-processing process before and after an etching process for slimming may be omitted.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A window manufacturing device comprising:
a fixing jig with a seating surface, on which a workpiece is fixed, wherein the seating surface comprises a curved surface or an inclined surface; and
an etching solution supply part disposed below the fixing jig, wherein a storage part is defined in the etching solution supply part to accommodate at least a portion of the seating surface.

2. The window manufacturing device of claim 1, wherein the seating surface protrudes toward the storage part and comprises the curved surface or the inclined surface without a discontinuity.

3. The window manufacturing device of claim 2, wherein a position of the fixing jig is adjusted in a way such that at least a portion of the seating surface is positioned inside the storage part.

4. The window manufacturing device of claim 2, wherein vacuum suction inlets are defined on the seating surface.

5. The window manufacturing device of claim 1, wherein the fixing jig comprises a groove portion concavely recessed toward the storage part and extending in one direction.

6. The window manufacturing device of claim 5, wherein the seating surface defines the groove portion.

7. The window manufacturing device of claim 6, wherein vacuum suction inlets are defined on the seating surface.

8. The window manufacturing device of claim 6, wherein the groove portion comprises the curved surface or the inclined surface without a discontinuity.

9. The window manufacturing device of claim 6, wherein the fixing jig is entirely accommodated in the storage part.

10. The window manufacturing device of claim 1, wherein an etching solution provided in the storage part is maintained at a constant level, or a level of the etching solution in the storage part is adjusted over time.

11. A window manufacturing method using a window manufacturing device comprising a fixing jig with a seating surface comprising a curved or inclined surface and an etching solution supply part disposed below the fixing jig with a storage part defined therein to accommodate at least a portion of the seating surface, the method comprising:
bending a base glass to include a bending portion corresponding to the seating surface;
fixing the bent base glass to the seating surface of the fixing jig;
supplying an etching solution to the storage part of the etching solution supply part; and
exposing the base glass, which is fixed to correspond to the curved or inclined surface, to the etching solution.

12. The window manufacturing method of claim 11, wherein the exposing the base glass to the etching solution comprises etching one exposed surface of the base glass to form a window, in which a recessed portion comprising a curved surface or an inclined surface is defined on a surface provided with the etching solution without a discontinuity.

13. The window manufacturing method of claim 11, wherein the exposing the base glass to the etching solution comprises controlling at least one selected from an exposure time to the etching solution or an amount of the etching solution to be provided, depending on a position of the base glass.

14. The window manufacturing method of claim 11, wherein
when the bending portion is fixed to the seating surface,
remaining portions of the base glass spaced apart from each other with the bending portion interposed therebetween are positioned in a direction in which the remaining portions are spaced apart from the storage part.

15. The window manufacturing method of claim 11, wherein
the seating surface, on which the base glass is fixed, has a shape protruding toward the storage part, and
the exposing the base glass to the etching solution comprises immersing one surface of the base glass in the etching solution of the storage part.

16. The window manufacturing method of claim 15, wherein, in the exposing of the base glass to the etching solution, a thickness of the base glass immersed in the etching solution gradually decreases from a central portion of the fixing jig towards an outer edge of the fixing jig.

17. The window manufacturing method of claim 11, wherein
the seating surface, on which the base glass is fixed, defines a groove portion concave in a direction toward the storage part, and
the exposing the base glass to the etching solution comprises accommodating the fixing jig, to which the base glass is fixed, in the storage part to provide the etching solution to a portion of the base glass.

18. The window manufacturing method of claim 17, wherein the exposing the base glass to the etching solution comprises controlling a level of the etching solution supplied to the storage part.

19. The window manufacturing method of claim 11, further comprising:
attaching a protective film to one surface of the base glass prior to the bending the base glass.

20. The window manufacturing method of claim 19, wherein, in the fixing the base glass to the seating surface of the fixing jig, the protective film side is attached to the seating surface.
